(19) United States
(12) Patent Application Publication
(10) Pub. No.: US 2003/0028404 A1
(43) Pub. Date: Feb. 6, 2003

(54) System and method for processing insurance claims

(76) Inventors: Robert Herron, Dallas, TX (US); Jeff Clark, Thornhill (CA); Andrew Lund, Pateley Bridge (GB); Farid Nagji, Plano, TX (US)

Correspondence Address: BERESKIN AND PARR, SCOTIA PLAZA, 40 KING STREET WEST-SUITE 4000 BOX 401, TORONTO, ON, M5H 3Y2, CA

(21) Appl. No.: 10/134,448

(22) Filed: Apr. 30, 2002

Related U.S. Application Data
(60) Provisional application No. 60/286,976, filed on Apr. 30, 2001.

(51) Int. Cl. G06F 17/60

(52) U.S. Cl. 705/4

(57) ABSTRACT

An insurance claim processing system and method which provides a plurality of prime movers such as insurers, intermediates, and risk managers and a plurality of suppliers including claim service providers, other professionals and vendors with the ability to simultaneously access, modify, and enhance a claim file remotely over a communications network. The claim processing system allows prime movers to select, interact with, assign tasks to, monitor, and evaluate claim service suppliers. As selected suppliers completed their assigned tasks, the suppliers are able to electronically attach electronic report documents to the claim file. Once all the tasks are completed, the prime mover associated with the claim file is notified and reviews the progress of the claim. Any additional tasks can be assigned and the claim adjustment can be completed. The relative performance of suppliers can be evaluated based on comparative performance records maintained by the system and future selection of suppliers can be informed by historical performance of suppliers. In this way, the system serves as an electronic clearing house for insurance claim processing.

This application claims priority from U.S. Provisional Patent Application No. 60/286,976 filed Apr. 30, 2001.

### FIELD OF THE INVENTION

This invention relates to a system and method for processing insurance claims and associated risk management data, and more particularly relates to a system and method for processing insurance claims from an initial claim through final settlement.

### BACKGROUND OF THE INVENTION

When an insurance claim is submitted by an insured party, the insurance claim must be “adjusted” which typically involves the generation and exchange of claim related information between and amongst a number of different entities such as insurers, risk managers, intermediaries (e.g. brokers, agents, banks which introduces business to an insurer), claim service providers (e.g. independent adjusters), vendors (e.g. contractors and suppliers of goods and services) and other professionals (e.g. accountants, lawyers, appraisers, etc.)

Claim service providers, vendors and other professionals (collectively “suppliers”) in the insurance field receive assignments from insurance companies and/or broker agents and generate reports, digital photographs, estimates, invoices and other documents. Typically, these materials are sent by the suppliers to the appropriate insurance company in a combination of electronic and hard copy format (e.g. mail, fax, e-mail attachments, etc.) Each insurance company also typically interfaces with intermediaries 16 and risk managers (collectively “prime movers”).

Insurance companies, intermediaries and risk managers generally utilize internal mainframe-based claim processing software systems to manage claim information. Since these systems were originally intended for internal use only, each company had claim processing software customized only for its own use. While claims management software for individual insurance companies may be written in the same high-level programming language (e.g. COBAL), one insurance company's software system is fundamentally incompatible with the software system of another insurance company.

One major drawback of the establishment of various proprietary claim processing systems is that data for each “paper” claim has to be entered into the computer to form an electronic claim. This requires manual entry of the data from materials submitted by claim service providers, vendors and other professionals into the in-house electronic system of each insurance company. As would be expected, manual entry of insurance claim related information results in periodic errors and omissions of information, adding complications, delays and expense to insurance claim processing.

More recently, insurance companies have begun to implement electronic filing of claim forms by suppliers of insurance claim information. However, there is continuing difficulty in integrating the information contained in the electronic claim form into the claims processing software at the insurance company. Also, a majority of suppliers have to be able to interface with a majority of insurance companies. Since there is no industry wide standard (e.g. in terms of actual software used and the specific claim information required on each insurance company's claim form) between the various mainframe computers of the various insurance companies, there exists substantial data incompatibility between and amongst insurance companies, intermediates, risk managers and suppliers (e.g. claim service providers, other professionals and vendors). Accordingly, filing and processing of insurance claims within the existing system results in high administrative costs as well as the real possibility of loss of claim related information through inaccurate manual reentry of claim related information.

While there exist certain commercial methods and systems for performing some of the administrative tasks in insurance claim processing, each of these computer programs requires certain types of data and each produces a certain type of data. The data required for the separate programs may overlap and lead to redundant data entry tasks. Also, data sharing between the different, discrete methods and systems that an insurance company uses may be difficult due to incompatible data formats. An insurance claim adjuster must spend time keeping track of, and running the separate programs. Accountants, appraisers, lawyers and others involved in claim processing often need to switch between and learn how to operate, separate software programs, each having unique data formats and interfaces. Insurance companies typically work with many separate computer files and pieces of paper which are generated and received from external parties during the course of processing a single claim.

Finally, in recent years, there has been a substantial growth in the number of claim service providers, vendors and other professionals in the insurance field. This has resulted in an explosive increase in the number of data exchange transactions between and amongst insurance companies and these parties that are required in order to process a claim. In view of this complexity, the usual market competition between claim service providers, vendors and other professionals is compromised as insurance companies are forced to work with certain parties with which they already have an established system for requesting and exchanging claim related information.

### SUMMARY OF THE INVENTION

An aspect of the present invention is to provide a method of processing an insurance claim by assigning tasks to suppliers, the method comprising the steps of:

(a) generating a claim datafile having data sections;

(b) selecting at least one supplier from a plurality of suppliers;

(c) assigning tasks to said at least one supplier over a communications network;

(d) providing each of said at least one selected supplier with access to claim datafile;

(e) providing said at least one selected supplier with the ability to electronically attach documents relating to completed tasks to the claim datafile over the communications network.

In another aspect, the present invention provides a system for processing a claim file by assigning tasks to suppliers, said system comprising:

(a) a network server for generating and maintaining a claim datafile, said claim datafile having a plurality of data sections;

(b) a communications network coupled to said network server;

(c) a user interface for selecting at least one supplier from a plurality of suppliers;

(d) a user interface for assigning tasks to said at least one supplier over a communications network;

(e) a user interface for providing each of said at least one selected supplier with access to said claim datafile; and

(f) a user interface for providing said at least one selected supplier with the ability to electronically attach documents relating to completed tasks to the claim datafile over the communications network.

In another aspect, the present invention provides a claim datafile for use in an insurance claim processing system which adjusts an insurance claim by assigning tasks to selected suppliers, the claim file comprising:

(a) a user interface that allows for the selecting of at least one supplier from a plurality of suppliers;

(b) a user interface for assigning at least one task to the at least one selected supplier; and

(c) a user interface which provides said at least one supplier with the ability to electronically attach a report document to the claim datafile.

### BRIEF DESCRIPTION OF THE DRAWINGS

In the accompanying drawings:

FIG. 1 is schematic drawing of an insurance claim processing system according to a preferred embodiment of the present invention;

FIG. 2 is a schematic drawing of the hardware components of the insurance claim processing system of FIG. 1;

FIG. 3 is a diagram of a sample claim file provided by the insurance claim processing system of FIG. 1;

FIG. 4A is a schematic diagram of the various databases maintained within the portal database of the insurance claim processing system of FIG. 1;

FIG. 4B is a pseudo-entity relationship diagram which illustrates the relationships between the various data entities stored within the portal database of claims processing system of FIG. 1;

FIG. 5 is a sample screen capture of the user interface provided by the claim processing system of FIG. 1;

FIG. 6A, 6B, 6C, and 6D are detailed database schema for the portal database of claims processing system of FIG. 1;

FIGS. 7A to 7D are sample Web browser screens showing sample user Web screens that are displayed on the user interface of the claims processing system of FIG. 1 and which illustrate permission rights;

FIG. 8 is a flowchart diagram illustrating one embodiment of the process steps executed by the claims portal of FIG. 1 for the TEAM REGISTRATION routine;

FIG. 9 is a flowchart diagram illustrating one embodiment of the process steps executed by the claims portal of FIG. 1 for the CLAIM INITIATION routine;

FIG. 10 is a flowchart diagram illustrating one embodiment of the process steps executed by the claims portal of FIG. 1 for the SUPPLIER INSTRUCTION routine;

FIG. 11 is a flowchart diagram illustrating one embodiment of the process steps executed by the claims portal of FIG. 1 for the SUPPLIER WORKING routine;

FIG. 12 is a flowchart diagram illustrating one embodiment of the process steps executed by the claims portal of FIG. 1 for the PRIME MOVER WORKING routine;

FIG. 13 is a schematic diagram showing the process steps for the processing of an typical insurance claim through the insurance claim processing system of FIG. 1; and

FIG. 14 is a schematic diagram that illustrates the revenue model utilized by the insurance claim processing system of FIG. 1.

### DETAILED DESCRIPTION OF THE PREFERRED EMBODIMENT

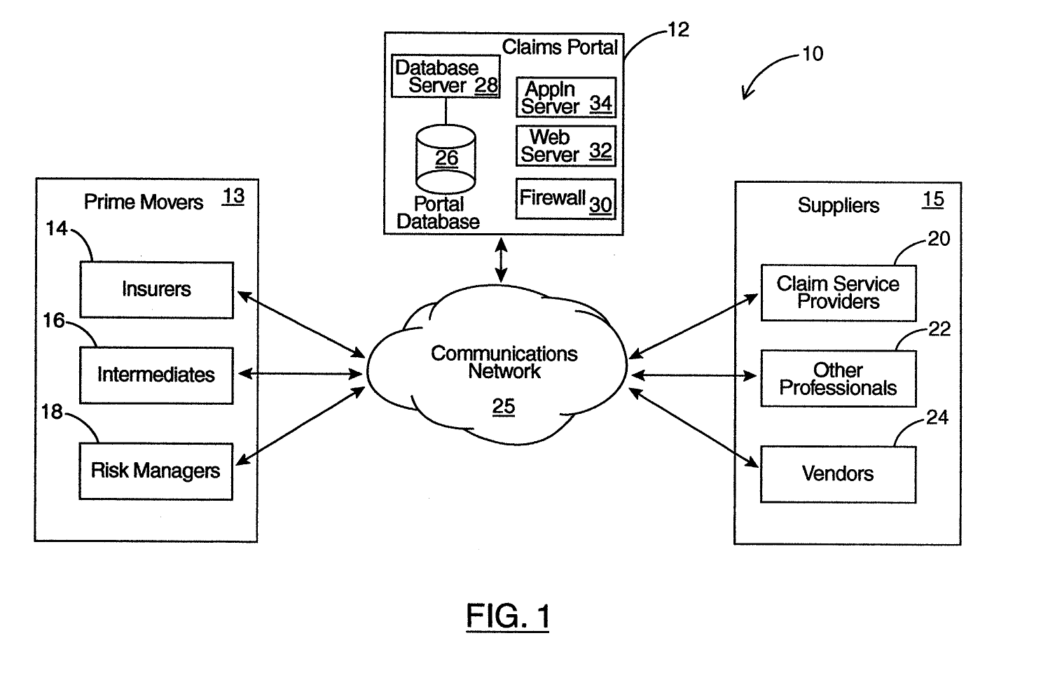

Reference is first made to FIG. 1 which shows an insurance claims processing system 10 made in accordance with a preferred embodiment of the invention. Claims processing system 10 comprises a claims portal 12 which operates over a communications network 25 and provides an exchange of electronic claim file data between insurance industry prime movers 13 and insurance industry suppliers 15. Claims portal 12 provides a common user interface which provides users with access and varying degrees of control over the electronic processing of an insurance claim and accordingly acts as a real-time electronic clearinghouse for prime movers 13 and suppliers 15.

Prime movers 13 are well known insurance-based entities who generally require the provision of insurance adjustment services, such as insurers 14, intermediataries 16, and risk managers 18. Suppliers 15 consist of well known claim adjustment suppliers and generally include claim service providers 20 (e.g. independent claim adjusters), other professionals 22 (e.g. accountants, lawyers, appraisers, etc.), and vendors 24 (e.g. contractors and suppliers of goods and services). Claims portal 12, prime movers 13 and suppliers 15 are all connected to communication network 25.

Communications network 25 can be implemented by various well known communication networks, for example, the Internet, cellular network, wireless network, radio frequency communication, or combinations of any of these networks. It should also be appreciated by one skilled in the art that claims processing system 10 is capable of operating to provide data communication between prime movers 13 and suppliers 15, regardless of the data communication platform utilized by either entity. It should be understood that the present invention is applicable to other types of communication devices such as satellite transceivers or any type of two-way wireless communication systems and that these techniques can be utilized to perform the function of the communication network 25. It is contemplated that various system users could connect to claims portal 12 through a variety of different means (e.g. cellphone, personal digital assistant, etc.) using a variety of different communications technologies. Preferably, all users would interface with claims portal 12 through a conventional Web browser (e.g. Netscape™, Internet Explorer™, etc.) on some type of computing device (e.g. personal computer, personal digital assistant, etc.)

Claims portal 12 includes a portal database 26 which is coupled to a database server 28, firewall server 30, a Web server 32, and an application server 34. Portal database 26 contains various types of insurance claim related information associated with specific on-going insurance claims as well as statistical or risk management information. Both kinds of information can be accessed by prime movers 13 and suppliers 15 in accordance with their permission rights as will be further described.

Claims portal 12 has been designed to operate in three general functional areas, namely the creation and maintenance of portal user accounts, the creation and subsequent working of a new claim and investigation of the claim. Claims portal 12 contains support claims and claim-related information associated with auto liability claims, worker's compensation claims, general liability claims, first party, accident benefit, injury benefit and property claims. It should be understood however, that various types of insurance claims are contemplated and that seven insurance types merely provide illustration of the more general underlying concepts associated with the present invention.

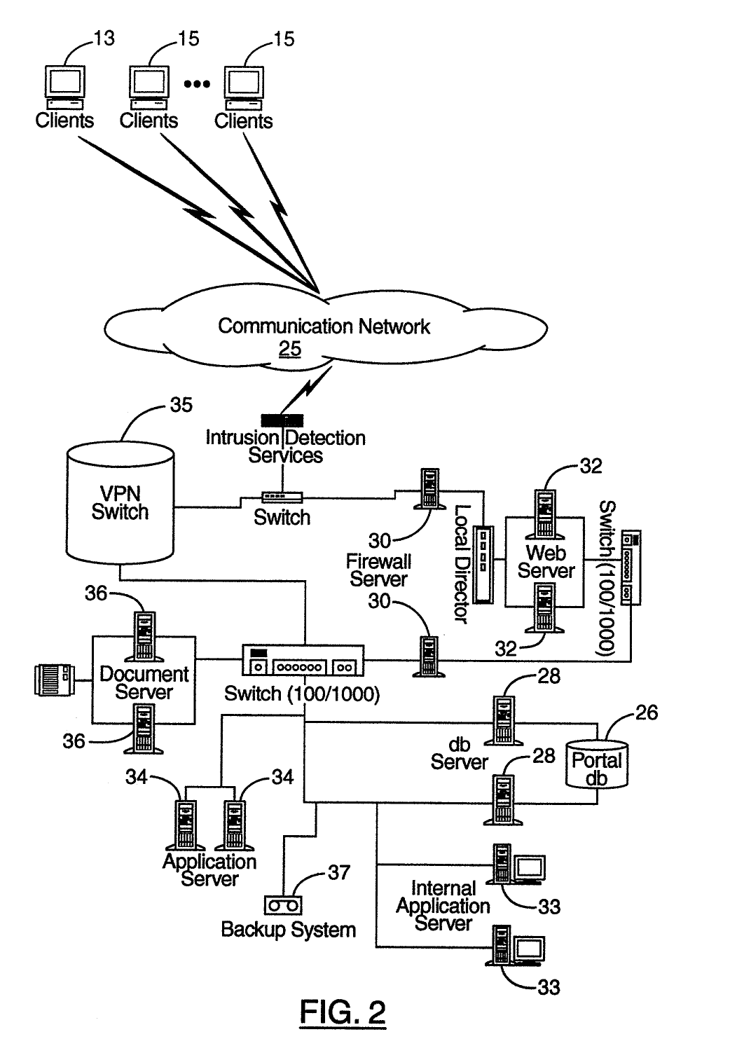

FIG. 2 shows a more detailed view of the hardware elements of claims processing system 10. As shown, prime movers 13 and suppliers 15 are considered to be Web clients and they may interface with claim processing system 10 using any personal computer or other device that is capable of running a Web browser program and which includes conventional components such as a processor, memory (e.g. RAM) and mass storage device and the like. These Web clients may utilize conventional operating systems such as Windows, Macintosh, or Linux as long as a number of internet access tools are supported, including a HTTP compliant Web browser (e.g. Netscape™ Navigator by Netscape Communications of Mountain View, Calif. or Internet Explorer™ by Microsoft Corporation of Redmond, Wash., etc.) As is conventionally known, Web browser is a software program that allows prime movers 14 and suppliers 15 to communicate with claims portal 12 to enable access to and viewing of HTML documents.

Claims portal 12 is implemented using a conventional distributed server architecture which comprises portal database 26, database server 28, firewall 30, Web server 32, application server 34, document server 36, backup system 37, virtual private network (VPN) switch 35 and internal application server 33. All of the servers are operated using a conventional operating systems (e.g. WebLogic™ 5.1 or Iplanet™ 4.1) on conventional operating platforms (e.g. Sun Solaris™ 8.0) as will be described. The overall system architecture of claim portal 12 is based on a Java 2 Enterprise Edition (J2EE) architecture framework using thin client architecture with Java Server Page (JSP), servlets and Enterprise Java™ Beans.

Generally, claims portal 12 receives and communicates information messages between and amongst users through browser based applets on a communications system based on direct socket connections and which is designed to support commercially available Web browsing software as discussed above. The applets are implemented in the Java programming environment, to maximize compatibility with Web browser versions. The network protocol for the socket communication can be based on TCP/IP and security and communication firewalls implemented by firewall server 30 can be provided using Secure Socket Layer (SSL) as is conventionally known and as will discussed.

Claims portal 12 utilizes complete redundant servers for all system components to ensure multiple network paths to provide the highest level of availability (i.e. to achieve near zero down time). The distributed server architecture also allows for modularity, redundancy, scalability and reduction of interference between applications. The use of separate servers to host the three main system components (i.e. Web server 32, application server 34, database server 28) also allows for additional layers of security. It should be understood that it would also be possible to implement all operations of claims portal 12 using fewer servers, each having higher memory and processing capacity, albeit with fewer of the operational advantages as discussed above.

Portal database 26 is implemented using a Oracle database cluster in Oracle™ 8.1.6 on two redundant Sun Solaris™ 8.0 servers. Database server 28 provides a relational database management system (RDBMS) for storage and access of the field level data and provides access to all the documents associated with an incident. The RDBMS is used to store data like transactions and lookup information that application server 34 creates and requires to perform the required business logic of the system.

Firewall 30 is implemented using the well known application filtering firewall Raptor™ 6.5 (Axent Technologies) running on the Microsoft Windows NT 4.0 platform with high availability modules installed and real secure modules for high availability and intrusion detection. Firewall 30 is located between the Internet and Web server 34, with another set running Cisco PIX between Web server 34 and application server 34, database server 28, document server 36 and backup system 37. The high availability module designates one of the firewall server as the back up server. If the primary server fails to respond then the second firewall server assumes control providing seamless content delivery to the system user. It is noteworthy that Raptor 6.5 uses a series of proxies (i.e. application filters) to inspect network traffic and provides support for bidirectional Network Address Translation (NAT) which identifies incoming/outgoing traffic as originating from some predetermined address. Claim portal 12 also implements a layered security model which utilizes conventionally known SSL, application, screen level and database level security mechanisms for added security, including network and database login for access to the internal network resources and various application functions as will be further discussed.

Web server 34 is utilized to operate a Web site which supports files in the form of HTML documents and pages and provides content to the Web browsers of prime movers 13 and suppliers 15. Web server 34 acts as a bridge between the Web browser and application server 34 and delivers a view to a user's Web browser using HTML over the HTTP/HTTPS communication protocol, as is conventionally known. As is known, in addition to HTML code, HTML documents can incorporate other information content, such as images, audio, video, executable programs, etc. (i.e. documents which relate to claim processing reports), which typically reside at Web server 34 but in the present invention also can reside on other servers, such as document server 36.

Application server 36 is implemented by Weblogic servers which perform the business level logic. Communication from application server 34 to database server 28 is handled by Java Database Connectivity (JDBC) software components in conjunction with a proprietary database client library. JDBC components are contained in the application server. The proprietary client library is located on the same node as the application server and communicates to the database with a proprietary protocol. Additionally, the Java 2 Enterprise Edition (J2EE) specification requires that servlets, EJBs, database sources, etc. publish and lookup information about the software components in a directory service component. Claim portal 12 utilizes the directory service within application server 34 to store information about users much like a database stores user information.

Document server 36 is used to store all of the associated claims processing documents and is implemented using a Sun A1000. As discussed above, document server 36 is used to store all claim processing related supplier reports and attachments which can be in a variety of formats (e.g. digital photographs, video, audio, etc.)

Backup system 37 is used to ensure that all data and source code associated with firewall server 30, database server 28, Web server 32, application server 34, and document server 36 are securely backed up in case of catastrophic failure conditions. Backup system 37 is implemented using a XXXX server for no-redundancy and failover solutions. Document server 36 is coordinated at database server 28 and uses Veritas NetBackup software together with Vertias Filesystem Snapshot to provide centralized backups of the systems while they are online.

VPN switch 35 provides a virtual private network and provides communication between datacenters to database server 28, Web server 32, application server 34, and document server 36. VPN switch 35 is implemented by a Nortel VPN communication switch part number CES 2600 3DES IPSEC (manufactured by Nortel Networks) which uses the well known Point-to-Point Tunnelling Protocol (PPTP) including compression and encryption. VPN switch 35 provides routing, firewall, bandwidth management, encryption, authentication and data integrity for secure tunnelling across claim portal 12 and the Internet. Large capacity 2600 VPN switch 35 provides connectivity on the order of 1000 tunnels for ample connectivity.

Finally, the operation of the various elements of claim portal 12, namely firewall server 30, database server 28, Web server 32, application server 34, VPN switch 35 can be controlled by human operators using internal application server 33. Specifically, internal application server 33 is implemented using Windows NT compatible servers and provides real time access to the various processes running on the various servers for routine maintenance, upgrades and rebooting as necessary.

Accordingly, a prime mover 13 or supplier 15 will connect through claims portal 12 to Web server 32 which hosts the claims portal Web site so that a servlet running on the system user's Web browser can sends messages to, and queries information from, portal database 26 via database server 28. In this way, claims portal 12 provides prime movers 13 and suppliers 15 with the ability to obtain information concerning the status of a insurance claim file as well as with the ability to enter or modify the claim file according to their permission rights.

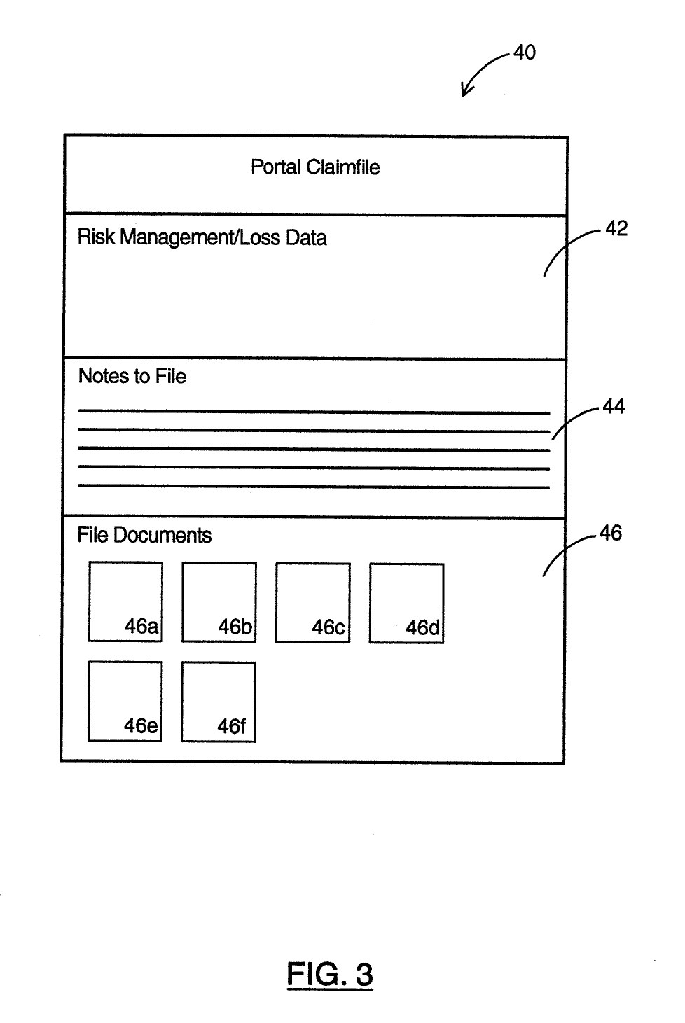

FIG. 3 is a schematic representation of a standard template portal claim file 40 which is utilized by claims processing system 10 to provide a common data exchange format for all parties associated with the processing of a claim file. Prime movers 13 and suppliers 15 can interact within the open-source data environment of the present invention by reviewing, adding to and removing electronic notations and digital document attachments, etc. from portal claim file 40, depending on their permission status, as will be further explained.

Portal claim file 40 is a “virtual” claims file which is used to contain risk management/loss data, notations, and digital document attachments. Portal claim file 40 consists of administrative information that details the loss involved, the type of assessments done (e.g. inspections, valuations, investigations, etc.), any information reports arising from such assessments, and the particular entities assigned to work on the claim. Portal claim file 40 contains specific sectors which each contain a portion of the information for processing of typical insurance claims through claims processing system 10. The sectors comprise risk management/loss data 42, notes to file 44, and claim file documents 46.

As previously discussed, claim file documents 46 can include but are not limited to: photographs, appraisals, police reports, medical information, estimates, receipts, inventory forms, statements and the like. In fact claim file documents should be considered to embrace many types of visual data (e.g. MRIs, EEG recordings, etc.) as well as strip charts, digitized video signals such as Moving Picture Experts Group (MPEG) compressed video signals, transcriptions of professional notes, estimates for repairs (e.g. for a house or car, etc.),appraisals, additional ASCII text, and the like. The only requirement regarding claim file documents 46 is that the information must be something that can be digitized (i.e. put into the form of a computer file).

Insurance adjusters (e.g. either in-house adjusters within insurance companies or independent claim adjusters) gather various types of reports and documents (e.g. medical reports, fire damage assessments, etc.) in the process of a claims investigation. These documents are used to support and/or substantiate claims or claims denials. In current practice, these documents are often attached in hard copy format (e.g. paper copies) to a report and mailed, faxed, and/or couriered to insurer 14 (FIG. 1). As previously discussed, this practise results in adminstration inefficiencies inherent in paper document management and manual entry of data.

In contrast, claims processing system 10 enables improved adminstration of the various documents collected by insurance adjusters through scanning of such documents at source and electronic incorporation within portal claim file 35. As discussed above, other types of documents with different formats (e.g. audio clips, video clips etc.) can also be stored within a portal claim file 40 to enhance the types of information that can be considered during the course of processing a claim. Generally, however portal claim file 40 provides users with a common platform to manage and interact with claim related information in real time terms during the course of a claim evaluation.

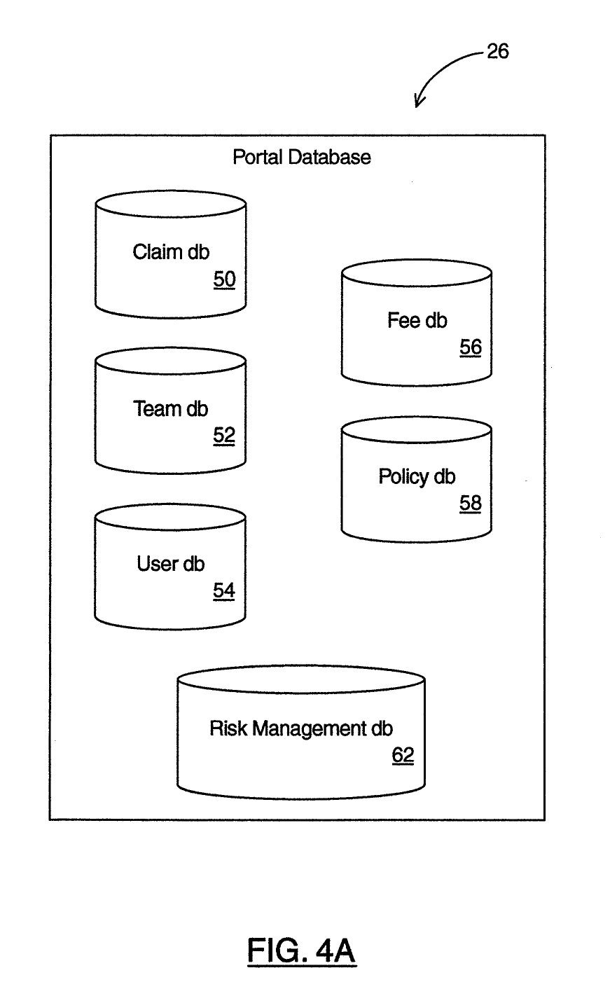

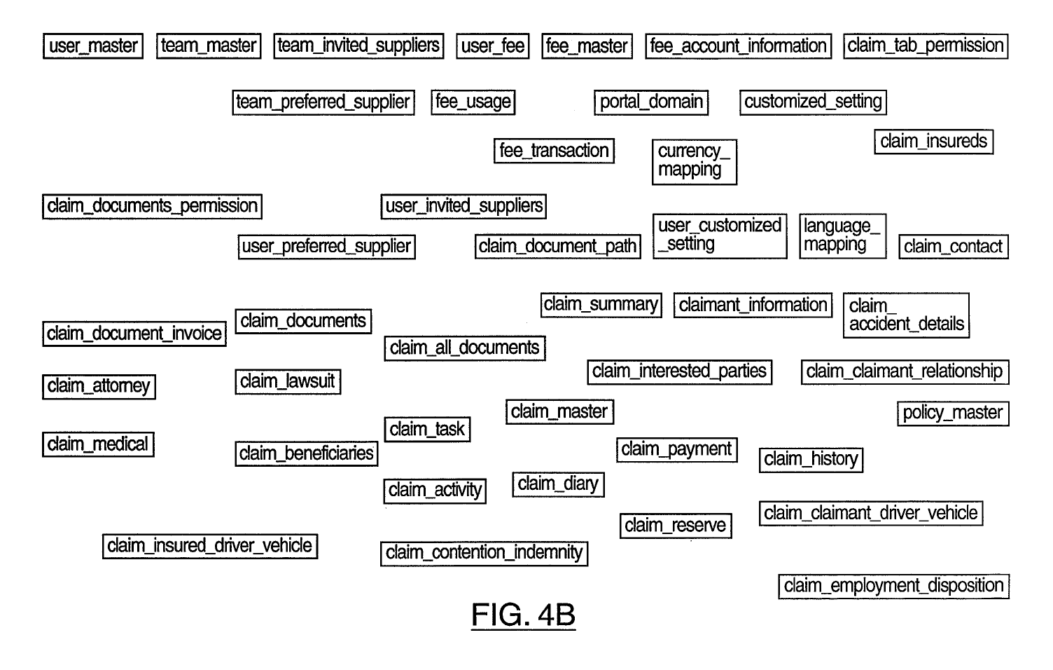

FIG. 4A is a schematic diagram of the various databases of claim processing related information maintained within the claims portal database 26 of insurance claim processing system 10. Specifically, portal database 26 contains a claim database 50, a team database 52, a user database 54, a fee database 56, a policy database 58, and a risk management database 62.

Referring to FIG. 4A and FIG. 4B, claim database 50 contains a number of data tables related to claim-specific information which are all related to a general claim_master table. For example, there are a number of tables that specifically relate to the documents that are generated by suppliers and which are maintained by the document server 36 such as claim_document, claim_document_permission, claim_document_path, claim_document_invoice, etc. Also, there are number of claim tables which relate to specific aspects of the claim such as claim_lawsuit, claim_attorney, claim_medical. Finally, there are a number of claim tables which relate to the administrative and financial management of claim file and the assignment of tasks, etc. such as claim_activity, claim_task, claim_reserve, claim_history.

Team database 52 contains data tables related to team-specific information which are related to a general team_master table. Specifically, the team_invited_suppliers table relates to the subset of suppliers who are part of the team's preferred suppliers. The team_preferred_suppliers table maintains records on those suppliers who have been invited to join a team's preferred supplier list.

User database 54 contains a number of data tables related to user-specific information which are all related to a general user_master table. Specifically, the user_fee table includes records which track the fee account of a supplier user.

Fee database 56 contains a number of data tables related to claim-specific information which are all related to a general fee_master table. Specifically, the fee_account_information table is used to track the account information for a particular supplier user.

The fee_usage table is used to track the usage of the financial fee system by a supplier user and fee_transation table stores records concerning the fee transactions that have occured.

Policy database 58 contains a general policy_master table which contain records of pointers that point to related policy-specific information which exists within other database tables in the system.

Risk management database 62 contains risk management/loss data that is relevant to prime movers 13, most notably risk managers 18. As will be understood by someone skilled in the art, information may have reports run against it and may be consolidated at the prime mover 13 level to product highly meaningful data mining. The information that flows from prime mover 13 electronically consolidating its claim service provider 15 information will help prime movers 13 to increase service levels while reducing costs. Examples of sample reports which can be run in respect of a series of claim service providers 15 include (avg. fee (aggregate/banded), avg. reporting time (aggregate), avg. investigation time (banded), avg. phone time (banded report), avg. correspondence time (banded), avg. claim paid time (aggregate/banded), avg. time to preliminary report, avg. time to first report, avg. file duration time, and correlation report comparing amt. spent on investigating and indemnity). The ability to centralize and coordinate data collection and storage will greately improve the accuracy of the information and accordingly the reliability of comparative analysis which can be performed.

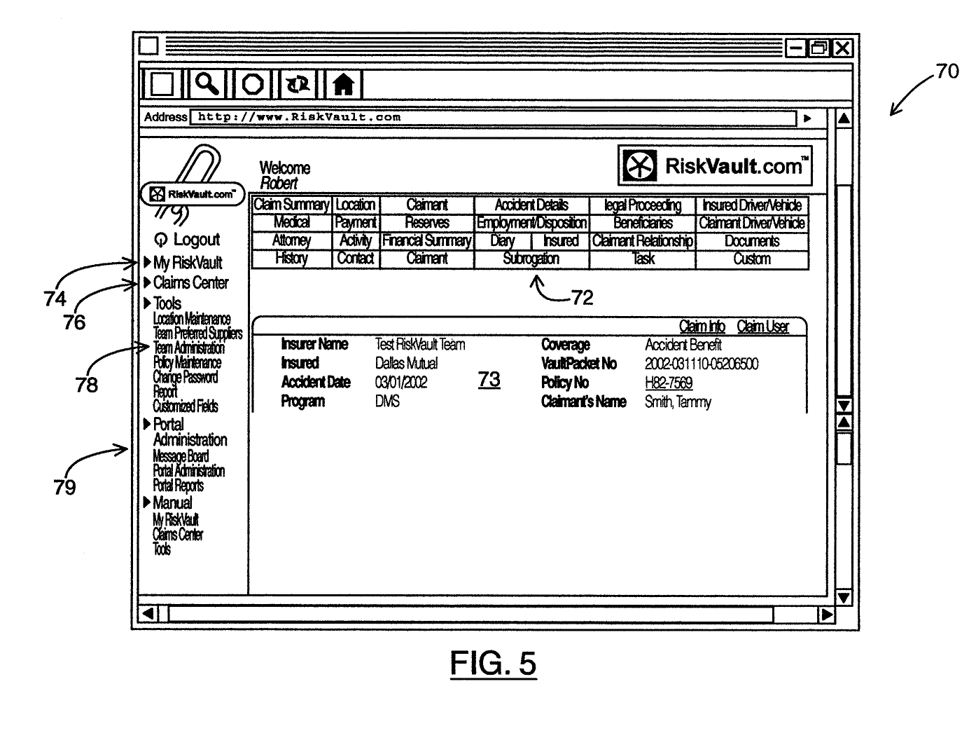

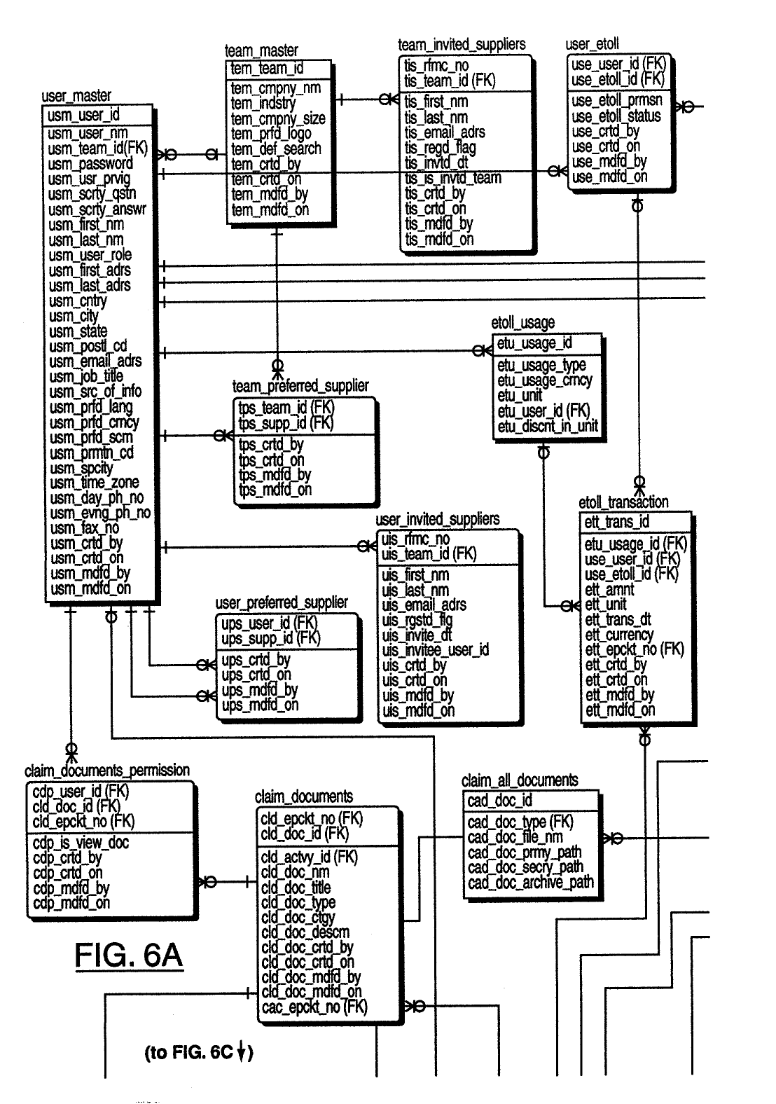

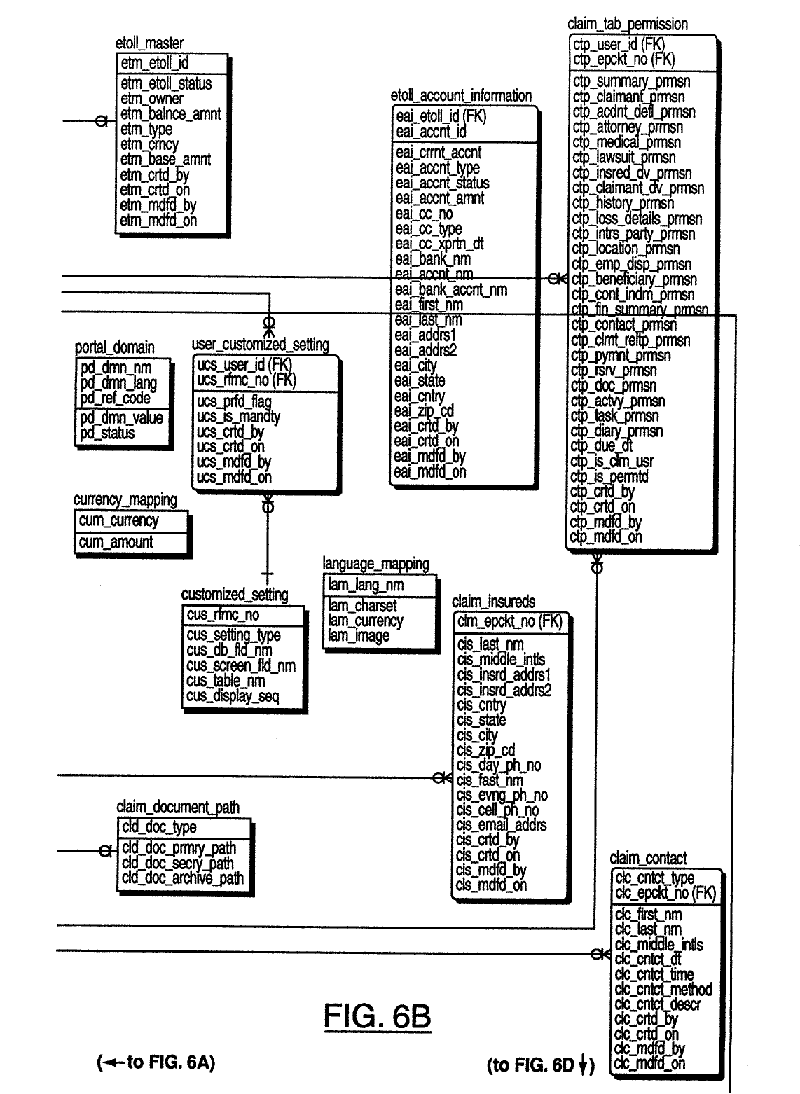

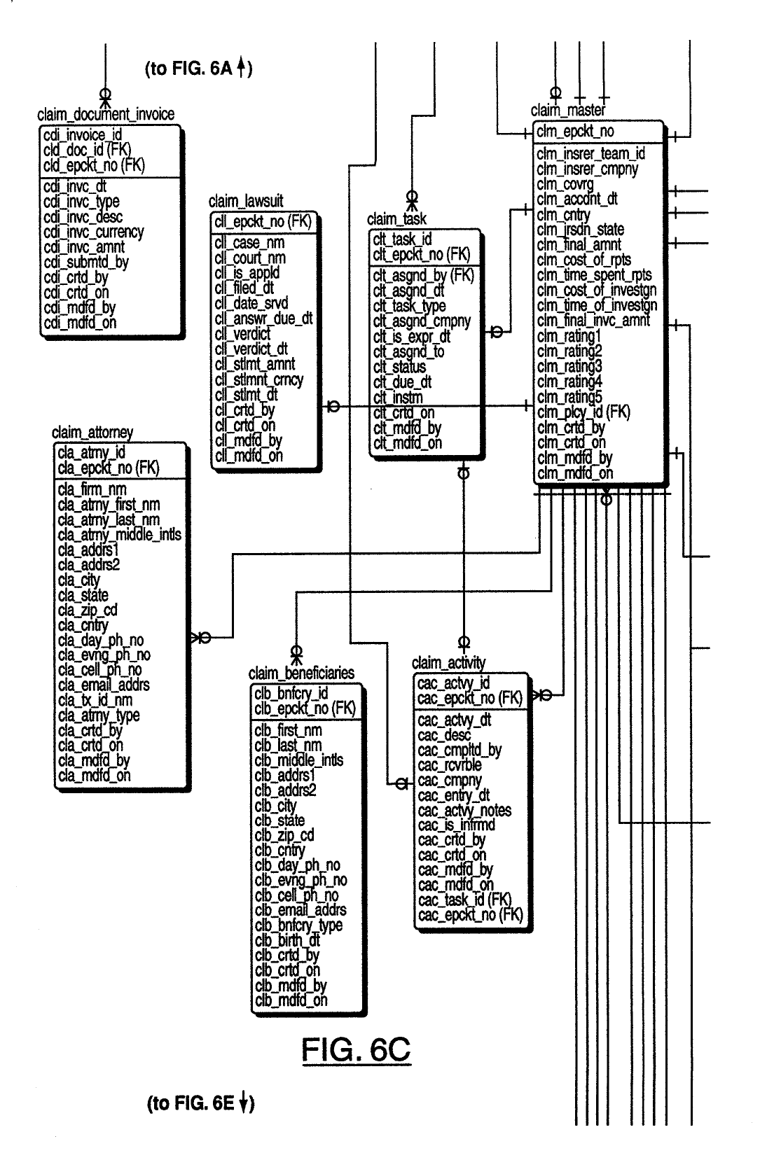

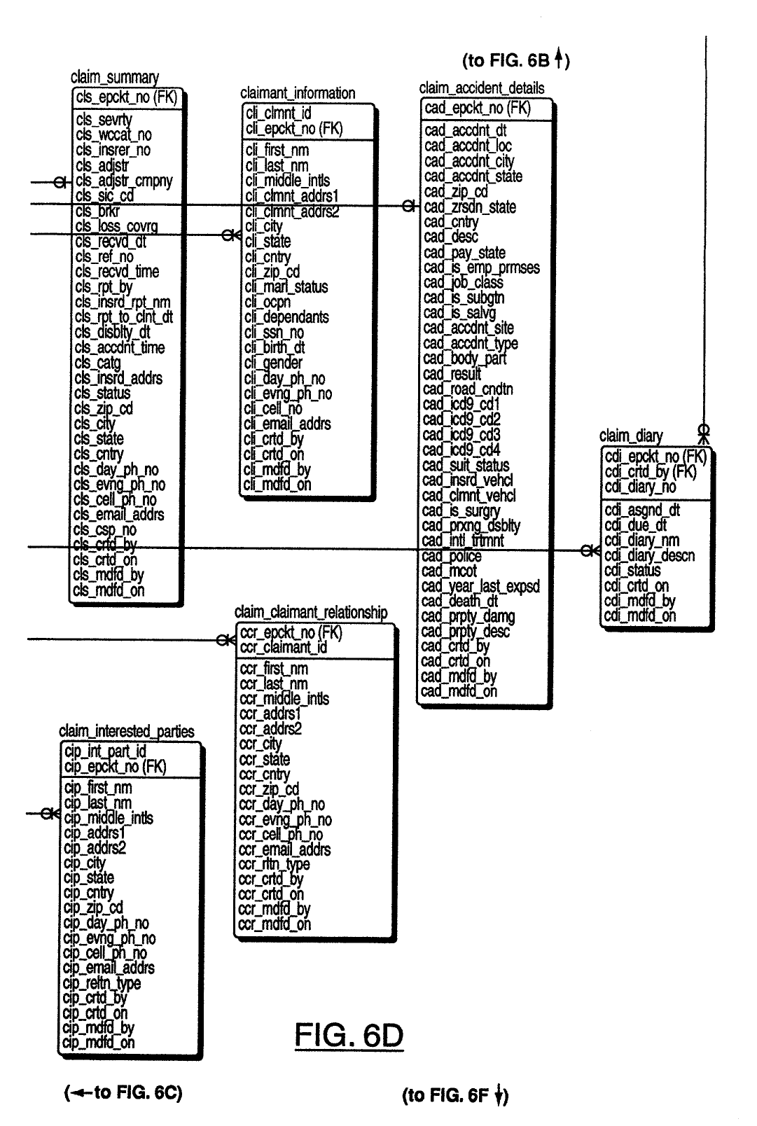

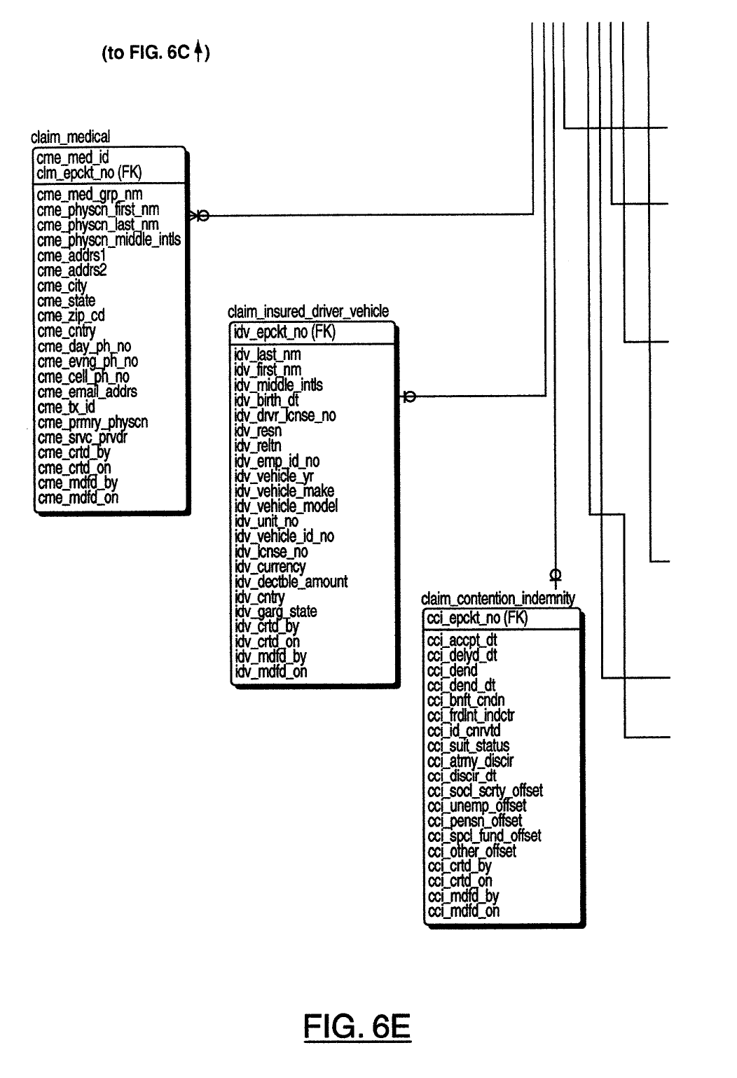

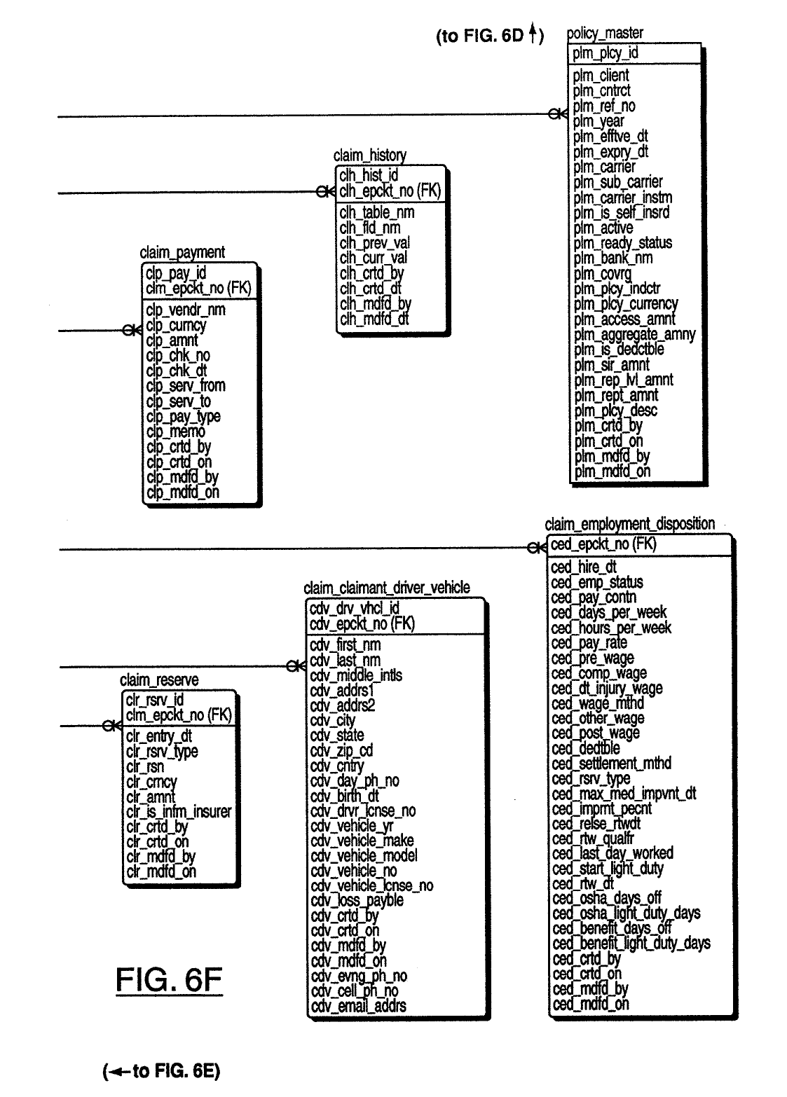

FIG. 4B is a pseudo-entity relationship diagram which illustrates the relationships between the various entities that are utilized within claims portal 12 to provide the functionality of the present invention. It should be noted that the various databases listed in FIG. 5 generally form the main types of entities. Accordingly, the entity diagram illustrates the relationship status of the various data elements which are located within particular databases within portal database 26. FIGS. 6A, 6B, 6C and 6D are interconnected sections of the overall database schema for portal database 26 illustrating in more detail the relationship between the various system data tables and their specific field contents.

FIG. 5 is a sample screen capture of the user interface provided by claim processing system 10 as it is displayed within a generic Web browser, shown generally as 70. This user interface provides prime movers 13 and suppliers 15 with access to the various application programs installed on Web server 32, database server 28, and application server 34 in the form of a number of primary function screens.

Specifically, there are a number of claim screens 72: CLAIM SUMMARY, RESERVES, CLAIMANT, LOCATION, FINANCIAL SYMMARY, BENEFICIARIES, EMPLOYMENT DISPOSITION, SUBROGATION, INSURED DRIVER/VEHICLE, CLAIMANT DRIVER/VEHICLE, CONTENTION/INDEMNITY OFFSET, CLAIMANT RELATIONSHIP, INSURED, CONTACT, ACTIVITY, ACCIDENT DETAILS, TASK, ATTORNEY, DIARY, MEDICAL, DOCUMENTS, LEGAL PROCEEDINGS, HISTORY, PAYMENT, INTERESTED PARTIES; user screens 74: GETTING STARTED, FAQ'S, MY PREFERRED SUPPLIERS, MY TOLL, MY PROFILE, MY TEAM, MY SERVICES, MY DIARY, MY TASKS, MY DELEGATED TASKS; utility screens 76: CLAIM SEARCH, CLAIM CREATE, CHANGE PASSWORD, REPORT, MANUAL; team administrator screens 78: LOCATION MAINTENANCE, TEAM PREFERRED SUPPLIERS, TEAM ADMINISTRATION, CUSTOMIZED FIELDS; and portal administration screens 79: MESSAGE BOARD, PORTAL ADMINISTRATION, PORTAL REPORTS. It should be understood that these screens along with other screens that are entered through these primary screens, allow prime movers 13 and suppliers 15 to participate in the insurance claim adjustment process by providing read/write access to various sections and aspects of the information stored in a claim file 40, according to their permission rights.

### Claim Screens

Specifically, the CLAIM SUMMARY claim screen allows either a prime mover 13 or a supplier 15 to enter and review details pertaining to an insurance claim. As shown in FIG. 5, a number of read-only pre-filled fields will appear in a permanent frame 73 which 10 is visible at all times when the user is viewing the claim. These fields will have been pre-filled by the claim creator (i.e. the user who creates the claim) through the operational CLAIM CREATE function, as will be described. The seven fields which appear within permanent frame 73 are as follows:

| Field | Representation | Status | Coverage |
|---|---|---|---|
| VaultPacket No | (pre-filled)- | Mandatory | WC, GL, AL, PY, |
| | read only | | IB, AB, FP |
| Policy Number | (pre-filled)- | Optional | WC, GL, AL, PY, |
| | read only | | IB, AB, FP |
| Insurer Name# | (pre-filled)- | Mandatory | WC, GL, AL, PY, |
| | read only | | IB, AB, FP |
| Coverage | (pre-filled)- | Mandatory | WC, GL, AL, PY, |
| | read only | | IB, AB, FP |
| Accident Date* | (pre-filled)- | Mandatory | WC, GL, AL, PY, |
| | read only | | IB, AB, FP |
| Program | (pre-filled)- | Optional | WC, GL, AL, PY, |
| | read only) | | IB, AB, FP |
| Claimant's Name1 | (pre-filled)- | Mandatory | WC, GL, AL, PY, |
| | read only | | IB, AB, FP |

#to be named as Insurer for PY, AL and GL
*to be named as Date of Loss for PY
1to be named Insured for PY

As can be seen from the table above, each of these fields have an associated representation status of pre-filled and read only. Also, all of the fields except POLICY NUMBER and Program are mandatory. Finally, each of these fields are applicable to the various insurance coverage types (i.e. WC or workers compensation, GL or general liability, AL or auto liability, and PY or property, IB for Injury Benefit, AB for Accident Benefit, FP for First Party), although some of the fields would be renamed in association with particular insurance coverage types as indicated in the table footnotes. Prime movers 13 and suppliers 15 are prompted to enter data as follows:

| Field | Representation | Status | Coverage |
|---|---|---|---|
| CSP Claim Number | (text box) | Optional | WC, GL, AL, |
| | | | PY, AB, FP, IB |
| Insurer Claim | (text box) | Optional | WC, GL, AL, PY, |
| Number | | | AB, FP, IB |
| Accident Time | (time—hh:mm) | Optional | WC, GL, AL, PY |
| | | | AB, FP, IB |
| Reference No. | (text box) | Optional | WC, GL, AL, PY |
| | | | AB, FP, IB |
| Severity Code | (look up) | Mandatory | WC, AB, IB, FP |
| Disability Date | (date— | Optional | WC |
| | mm/dd/yyyy) | | |
| WC Catastrophe | (text box) | Mandatory | WC |
| No. | | | |
| Status | (drop-down) + | Mandatory | WC, GL, AL, PY |
| | (date— | | AB, FP, IB |
| | mm/dd/yyyy) | | |
| Adjuster | (look up) | Mandatory | WC, GL, AL, PY |
| | | | AB, FP, IB |
| Adjuster Company | (text box) | Mandatory | WC, GL, AL, PY |
| Name | | | AB, FP, IB |
| Received Date | (date— | Mandatory | WC, GL, AL, PY, |
| | mm/dd/yyyy) | | AB, IB, FP |
| Received Time | (time—hh:mm) | Optional | WC, GL, AL, PY, |
| | | | AB |
| Report By | (look up) | Optional | WC, AB, IB, FP |
| Report Date | (date— | Optional | WC |
| | mm/dd/yyyy) | | |
| Insured Report No. | (text box) | Optional | WC, AB, IB, FP |
| Category | (look up) | Optional | WC, AB, IB, FP |
| SIC Code | (look up) | Mandatory | WC, IB, FP |
| Broker | (text box) | Mandatory | GL, AL, PY |
| Handling | (scrollable | Optional | WC, GL, AL, PY, |
| Instructions | text box) | | IB, FP |
| Insured Driver | (text box) | Optional | AL |
| Type of Loss | (text box) | Optional | GL, PY |
| Insured Address | (text box) | Optional | GL, AL, PY |
| City | (text box) | Optional | GL, AL, PY |
| State | (look up) | Optional | GL, AL, PY |
| Country | (dropdown) | Optional | GL, AL, PY |
| Zip/Postal Code | (text box) | Optional | GL, AL, PY |
| Day Phone | (look up) | Optional | GL, AL, PY |
| Evening Phone | (look up) | Optional | GL, AL, PY |
| Cell Phone | (look up) | Optional | GL, AL, PY |
| Ach | (Radio Button) | Optional | AB, FP, IB |
| Program | (Text Box) | Optional | WC, GL, AL, PY, |
| | | | IB, AB, FP |
| Email Address | (Text Box) | Optional | PY, GL, AL |
| Policy Number | (pre-filled)- | Optional | WC, GL, AL, PY, |
| | editable | | AB, FP, IB |

If the value selected for STATUS is “closed” then the user will be requested to provide additional information through a pop-up screen: FINAL SETTLEMENT AMOUNT, COST OF ALL REPORTS, TIME SPENT ON REPORTING, COST FOR INVESTIGATION, TIME SPENT ON CLAIM INVESTIGATION, FINAL INVOICE AMOUNT. If the value selected for STATUS is “cancelled” then the system will determine if total for PAYMENTS (see below) and RESERVES (see below) are zero. If so, then the status will be changed to “cancelled”. However, if the values are not zero then the user will be informated that there are payment and/or reserve outstanding balances that must be reversed prior to cancellation of the claim. The user can close CLAIM SUMMARY by clicking a conventional CLOSE button at the top left of the subscreen. Clicking on POLICY NUMBER will link the user to the POLICY screen (as discussed below). All of this field information is store in the claim_summary table of portal database 26.

The RESERVES claim screen allows an authorized prime mover 13 or a supplier 15 to create reserves for a given claim. If an authorized user clicks on CREATE RESERVE button (not shown), they would be prompted to provide reserve information as follows:

| Field | Representation | Status |
|---|---|---|
| Entry Date | (system generated) | Mandatory |
| Reserve Type | (drop down) | Mandatory |
| Reason | (text box) | Mandatory |
| Currency type | (drop down) | Mandatory |
| Amount | (text box) | Mandatory |
| Inform Carrier/Insurer | (check box) | Optional |

The user will be required to select a particular RESERVE TYPE such as “expense”, “legal”, “indemnity”, “personal disability”, etc. It should be noted that an authorized user may add positive or negative reserves (by clicking on “CREATE RESERVE link”). After providing the information listed in the above table, the user may save the entries in the reserve table of portal database 26 and update the RESERVE summary screen with certain of the newly added reserve details and the bolded fields above will be displayed on the RESERVE summary screen as well as CLAIM BASE CURRENCY which is the currency of the first financial transaction on the claim and which is shown on all the financial screens. The RESERVE summary screen will display the gross reserve amount for various reserve types and further details about a particular reserve can be obtained by clicking the reserve type (i.e. TYPE, REASON, CURRENCY, AMOUNT, ENTRY DATE). If the value of INFORM CARRIER/INSURER is changed from it's default setting of “no” to “yes” then an e-mail is generated and sent to the claim creator.

The CLAIMANT claim screen captures information about the claimant and a claim user with the appropriate permission (i.e. EDIT permission for the CLAIMANT screen) can enter data for the fields listed below:

| Field | Representation | Status |
|---|---|---|
| Last Name | (text box) | Optional |
| First Name | (text box) | Optional |
| MI | (text box) | Optional |
| Address 1 | (text box) | Optional |
| Address 2 | (text box) | Optional |
| City | (text box) | Optional |
| State/Province | (look up) | Optional |
| Zip Code | (text box) | Optional |
| Country | (drop down) | Optional |
| Marital status* | (look up) | Optional |
| Dependents* | (text box) | Optional |
| Occupation* | (text box) | Optional |
| Social Security* No. | (text box) | Optional |
| Birth Date | (date—mm/dd/yyyy) | Optional |
| Gender | (look up) | Optional |
| Day Phone | (text box) | Optional |
| Evening Phone | (text box) | Optional |
| Cell Phone | (text box) | Optional |
| E-Mail Address | (text box) | Optional |

*required only for WC

When the user presses the SAVE button, the submitted information will be stored within the claimant_information table within portal database 26. This action will also update the CLAIMANT summary screen with the claimant details listed above. When the above information is entered and the SAVE button is clicked, the CLAIMANT summary screen will display the bolded fields as shown above. An authorized claim user may VIEW details for a particular claimant by clicking on the relevant link under last name which will cause the balance of the information to be displayed. A user can add data about another claimant by clicking the ADD button.

The LOCATION claim screen captures information about the location where the loss has taken place. A primer mover 13 or supplier 15 may provide view and/or details about a claim location by entering data in the fields as set out below:

INPUTS:

| Field | Representation | Status | Coverage |
|---|---|---|---|
| Location Name | (text box) | Optional | WC, AB, FP, IB, |
| Entity Name | (text box) | Optional | WC, AB, FP, IB, |
| Division Name | (text box) | Optional | WC, AB, FP, IB, |
| Region Name | (text box) | Optional | WC, AB, FP, IB, |
| Section Name | (text box) | Optional | WC, AB, FP, IB, |

When the user presses the SAVE button, the submitted information will be stored within the claim_location table The FINANCIAL SUMMARY SCREEN allows authorized users to view the incurred amounts of a claim which is the sum of reserves and payments. A primer mover 13 or supplier 15 may provide view and/or details about a claim's financial information by viewing data in the fields as set out below:

INPUTS:

| Field | Representation | Status |
|---|---|---|
| Claim Base Currency | (Pre-filled) | Mandatory |
| Type | (Pre-filled) | Mandatory |
| Currency | (Pre-filled) | Mandatory |
| Incurred | (Pre-filled) | Mandatory |
| Paid | (Pre-filled) | Mandatory |
| Reserves | (Pre-filled) | Mandatory |

The BENEFICIARIES claim screen captures information about the claimant's beneficiaries. A primer mover 13 or supplier 15 may provide view and/or details about a claim beneficiaries by entering data in the fields as set out below

Inputs: AB, FP, IB, WC

| Field | Representation | Status |
|---|---|---|
| Beneficiary code | (look up) | Mandatory |
| Last Name | (text box) | Optional |
| First Name | (text box) | Optional |
| MI | (text box | Optional |
| Address 1 | (text box) | Optional |
| Address 2 | (text box) | Optional |
| City | (text box) | Optional |
| State/Province | (look up) | Optional |
| Zip/Postal | (text box) | Optional |
| Country | (dropdown) | Optional |
| Day Phone | (text box) | Optional |
| Evening Phone | (text box) | Optional |
| Cell Phone No. | (text box) | Optional |
| E-mail Address | (text box) | Optional |
| Birth Date | (date—mm/dd/yyyy | Optional |

When the user presses the SAVE button, the submitted information will be stored within the claim_beneficiaries table

The EMPLOYMENT DISPOSITION claim screen captures information about the employment/disposition information. A primer mover 13 or supplier 15 may provide view and/or details about a claim's employment disposition by entering data in the fields as set out below:

Inputs: AB, FP, IB, WC

| Field | Representation | Status |
|---|---|---|
| Hire Date | (text box) | Mandatory |
| Employee Status | (look up) | Mandatory |
| Pay Continuation | (drop down) | Optional |
| Days per week | (text box) | Optional |
| Hours per week | (text box) | Optional |
| Pay rate | (text box) | Optional |
| Pre Wage | (text box) | Optional |
| Comp Wage | (text box) | Optional |
| Date of injury Wage | (dropdown) | Optional |
| Wage Method | (look up) | Optional |
| Other wage | (text box) | Optional |
| Post Wage | (text box) | Optional |
| Deductible | (drop down) | Optional |
| Settlement Method | (look up) | Optional |
| Reserve Type | (look up) | Optional |
| Max. Medical | (date—mm/dd/yyyy) | Optional |
| Improvement Date | | |
| Percent Impairment | (text box) | Optional |
| Release to RTW Date | (date—mm/dd/yyyy) | Optional |
| RTW Qualifier | (look up) | Optional |
| Last Day Worked | (date—mm/dd/yyyy) | Optional |
| Start Light Duty Date | (date—mm/dd/yyyy) | Optional |
| RTW Date | (date—mm/dd/yyyy) | Optional |
| OSHA Days Off | (text box) | Optional |
| OSHA Light Duty Days | (text box) | Optional |
| Benefit Days Off | (text box) | Optional |
| Benefit Light Duty Days | (text box) | Optional |

When the user presses the SAVE button, the submitted information will be stored within the claim_employment_disposition table

The SUBROGRATION claim screen captures information about subrogation. A primer mover 13 or supplier 15 may provide view and/or details about a claim's subrogation by entering data in the fields as set out below:

Inputs: AB, FP, IB, WC, AL, PY

| Field | Representation | Status |
|---|---|---|
| Location of Loss | (text box) | Optional |
| Date/Time of Loss | (date) | Optional |
| Cause of Loss | (text box) | Optional |
| Circumstance | (scroll box) | Optional |

When the user presses the SAVE button, the submitted information will be stored within the claim_subrogation and/or claim_subro_det table

The INSURED DRIVER VEHICLE claim screen captures information about the insured driver vehicle at the time the incident occurred. A primer mover 13 or supplier 15 may provide view and/or details about a claim's insured driver/vehicle by entering data in the fields as set out below:

Inputs: AB, FP, IB, AL, PY

| Field | Representation | Status |
|---|---|---|
| Driver Last Name | (text box) | Optional |
| Driver First Name | (text box) | Optional |
| Driver MI | (text box) | Optional |
| Driver Birth Date | (date—mm/dd/yyyy) | Optional |
| Driver License Number | (text box) | Optional |
| Reason | (text box) | Optional |
| Relation to Insured | (look up) | Optional |
| Employee ID Number | (text box) | Optional |
| Vehicle Year | (text box) | Optional |
| Vehicle Make | (text box) | Optional |
| Vehicle Model | (text box) | Optional |
| Unit Number | (text box) | Optional |
| Vehicle ID Number | (text box) | Optional |
| Vehicle License Number | (text box) | Optional |
| Deductible | (text box) | Optional |
| Garage State | (look up) | Optional |

When the user presses the SAVE button, the submitted information will be stored within the claim_insured_driver_vehicle table.

The CLAIMANT DRIVER VEHICLE claim screen captures information about the claimant driver/vehicle at the time the incident occurred. A primer mover 13 or supplier 15 may provide view and/or details about a claim's claimant driver/vehicle by entering data in the fields as set out below:

Inputs: AB, FP, IB, AL, GL

| | | |
|---|---|---|
| Driver Last Name | (text box) | Mandatory |
| Driver Last Name | (text box) | Mandatory |
| Driver MI | (text box) | Optional |
| Address1 | (text box) | Mandatory |
| Address2 | (text box) | Optional |
| City | (text box) | Mandatory |
| State/Province | (look up) | Mandatory |
| Zip/Postal Code | (text box) | Mandatory |
| Country | (dropdown) | Mandatory |
| Day Phone | (text box) | Mandatory |
| Evening Phone | (text box) | Optional |
| Cell Phone | (text box) | Optional |
| E-mail Address | (text box) | Optional |
| Driver Birth Date | (look up) | Mandatory |
| Driver License Number | (text box) | Mandatory |
| Vehicle Year | (text box) | Mandatory |
| Vehicle Make | (text box) | Mandatory |
| Vehicle Model | (text box) | Mandatory |
| Vehicle ID Number | (text box) | Mandatory |
| Vehicle License Number | (text box) | Mandatory |
| Loss Payable | (text box) | Mandatory |

When the user presses the SAVE button, the submitted information will be stored within the claim_claimant_driver_vehicle table.

The CONTENTION INDEMNITY OFFSET claim screen captures information about contention indemnity offset. A primer mover 13 or supplier 15 may provide view and/or details about a claim's contention/indemnity by entering data in the fields as set out below:

Inputs: AB, FP, IB, AL, PY

| Field | Representation | Status |
|---|---|---|
| Accept Date | (date—mm/dd/yyyy) | Optional |
| Delayed Date | (date—mm/dd/yyyy) | Optional |
| Denied | (drop down) | Optional |
| Denied Date | (date—mm/dd/yyyy) | Optional |
| Benefit Condition | (look up) | Optional |
| Fraudulent Indicator | (look up) | Optional |
| Controverted Case | (drop down) | Optional |
| Suit Status | (look up) | Optional |
| Attorney Disclosure | (look up) | Optional |
| Form Filed | | |
| Attorney Disclosure Date | (date—mm/dd/yyyy) | Optional |
| Social Security Offset | (drop down) | Optional |
| Unemployment Offset | (drop down) | Optional |
| Pension Offset | (drop down) | Optional |
| Special Fund Offset | (drop down) | Optional |
| Other Offset | (drop down) | Optional |

When the user presses the SAVE button, the submitted information will be stored within the claim_contention_indemnity table.

The CLAIMANT RELATIONSHIP claim screen captures information about the claimant relationships to the claim. A primer mover 13 or supplier 15 may provide view and/or details about a claim's claimant relationship by entering data in the fields as set out below:

Inputs: AB, FP, IB, AL, GL

| Field | Representation | Status |
|---|---|---|
| Last Name | (text box) | Mandatory |
| First Name | (text box) | Mandatory |
| MI | (text box) | Optional |
| Address1 | (text box) | Optional |
| Address2 | (text box) | Optional |
| City | (text box) | Optional |
| State | (look up) | Optional |
| Country | (drop down) | Optional |
| Zip Code | (text box) | Optional |
| Day Phone | (text box) | Optional |
| Evening Phone | (text box) | Optional |
| Cell Phone | (text box) | Optional |
| E-mail | (text box) | Optional |
| Relationship | (drop down) | Mandatory |

When the user presses the SAVE button, the submitted information will be stored within the claim_claimant_relationship table.

The INSURED claim screen captures information about the insured. A primer mover 13 or supplier 15 may provide view and/or details about a claim's insured by entering data in the fields as set out below:

Inputs: AB, FP, AL, GL, IB, WC, PY

| Field | Representation | Status |
|---|---|---|
| Insured Company | (test box) | Optional |
| Contact Last Name* | (text box) | Optional |
| Contact First Name* | (text box) | Optional |
| Insured Address 1 | (text box) | Optional |
| Insured Address 2 | (text box) | Optional |
| Insured City | (text box) | Optional |
| Insured Country | (text box) | Optional |
| Insured State | (text box) | Optional |
| Insured Zip | (text box) | Optional |
| Insured Day Phone | (text box) | Optional |
| Insured Night Phone | (text box) | Optional |
| Insured eMail | (text box) | Optional |

*Mandatory if Insured Company is not filled.

When the user presses the SAVE button, the submitted information will be stored within the claim_insured table.

The CONTACT claim screen captures information detailing the initial contacts for a particular claim. A primer mover 13 or supplier 15 may provide view and/or details about a claim's contact by entering data in the fields as set out below:

Inputs:

| Field | Representation | Status |
|---|---|---|
| First Name | (text box) | Mandatory |
| Last Name | (text box) | Mandatory |
| MI | (text box) | Optional |
| Contact Date | (text box) | Mandatory |
| Contact Time | (text box) | Mandatory |
| Contact Method | (drop down) | Mandatory |
| Contact Description | (scrollable text box) | Mandatory |

When the user presses the SAVE button, the submitted information will be stored within the claim_contact table.

The ACTIVITY claim screen enables a supplier 15 to create activity notes and attach documents to a claim file 40 while working on a claim. The following information are the inputs for the claim_activity table in portal database 26:

| Field | Representation | Status |
|---|---|---|
| Activity Date | (date) | Mandatory |
| Description | (text box) | Mandatory |
| Completed By | (system generated) | Mandatory |
| Company | (text box) | Mandatory |
| Entry Date | (system generated) | Mandatory |
| Activity Note | (scrollable text box) | Mandatory |
| Time Taken (hours) | (text box) | Optional |
| Base Rate | (text box) | Optional |
| Activity Cost | (test Box) | Optional |
| Currency | (Drop Down) | Optional |
| Inform Carrier/Insurer | (check box) | Mandatory |
| Document Name | (text box) | Optional |
| Notify Task Assigner | (check Box) | Optional |
| Document Title | (text box) | Optional |
| Document Type | (drop down) | Optional |
| Document Category | (drop down) | Optional |
| Document Description | (check box) | Optional |
| Creation Date | (system generated) | Optional |
| Invoice Date | (date—mm/dd/yyyy) | Optional |
| Invoice Type | (drop down) | Optional |
| Invoice Description | (scrollable text box) | Optional |
| Currency Type | (drop down) | Optional |
| Amount | (text box) | Optional |
| Submitted By | (text box) | Optional |

In the ACTIVITY summary screen, the user may view the listing of all the activities for an Electronic File Number. After providing the information, the user saves it by clicking the SAVE button which will update the ACTIVITY summary screen with the newly added details listed above. When the above information is entered and the SAVE button is clicked, the entered information will be stored in the claim_activity table of portal database 26 and the ACTIVITY summary screen will display the bolded fields as shown above.

A user may create an activity by entering the mandatory fields in the detail screen. A user may select the document to be attached by clicking on the BROWSE button. Once selected, the file and its path will be displayed in the “Document Name” field (i.e. to serve as a pointer). Also, a creation date/invoice date will be generated by the system the moment the user attaches a document/invoice, respectively. The user is queried to enter data for various document-related fields (i.e. Document; Title; Document Type (e.g. Microsoft Word™, Excel™, PowerPoint™, GIF, JPEG, other); Document Category (letters, photos, scanned documents, reports, invoice, other) and Document description). A user may view details for a specific ACTIVITY by clicking on the relevant link under Description.

A user can grant permissions to users to view a document by clicking on the ADD USER link which takes the user to a SUPPLIER search screen from where he/she can select and add a supplier into the USER DOCUMENT LIST. If the user selects “yes” for INFORMING CARRIER/INSURER (“no” is the default) then an e-mail message will be sent to the specified carrier/insurer (i.e. team administrator of the insurer's team) and generate Activity Numbers, Document Id's and an Invoice Id. Finally, when the user presses the SAVE button the ACTIVITY summary screen is updated with the newly created activity details.

The ACCIDENT DETAILS claim screen captures details about the accident as follows:

| Field | Representation | Status | Notes |
|---|---|---|---|
| Accident date | (date— | Mandatory | |
| | mm/dd/yyyy) | | |
| Accident Location | (text box) | Optional | |
| Accident City | (text box) | Optional | |
| Accident State | (look up) | Optional | |
| Zip Code | (text box) | Optional | |
| Jurisdiction State | (look up) | Optional | |
| Country | (text box) | Optional | |
| Accident Description | (scrollable text) | Optional | |
| Pay Type | (look up) | Optional | required only in WC |
| Employer Premises | (Radio Button) | Optional | required only in WC |
| Job Class | (look up) | Optional | required only in WC |
| Subrogation | (Radio Button) | Optional | |
| Accident Site | (look up) | Optional | |
| Accident Type | (look up) | Optional | For PY label should |
| | | | be Type of Loss |
| Body Part | (look up) | Optional | Not Required in PY |
| Result | (look up) | Optional | Not Required in PY |
| ICD-9 Code 1 | (look up) | Optional | required only in WC |
| ICD-9 Code 2 | (look up) | Optional | required only in WC |
| ICD-9 Code 3 | (look Up) | Optional | required only in WC |
| ICD-9 Code 4 | (look up) | Optional | required only in WC |
| Surgery | (Radio Button) | Optional | required only in WC |
| Pre-existing Disability | (Radio Button) | Optional | required only in WC |
| Initial Treatment | (look up) | Optional | required only in WC |
| MCOT | (look up) | Optional | required only in WC |
| Year Last Exposed | (text box) | Optional | required only in WC |
| Death Date | (date— | Optional | not Required in PY |
| | mm/dd/yyyy) | | |
| Police | (look up) | Optional | not Required in WC |
| Suit Status | (look up) | Optional | not Required in WC |
| Salvage | (look up) | Optional | required only in PY, |
| | | | AL |
| Road Condition | (look up) | Optional | required only in PY, |
| | | | AL |
| Insured Vehicle | (look up) | Optional | required only in PY, |
| | | | AL |
| Claimant Vehicle | (look up) | Optional | required only in PY, |
| | | | AL |
| Property Damage | (look up) | Optional | not Required in WC |
| PropertyDescription | (scrollable text) | Optional | Required only in PY |

After providing information, the user may save it by clicking the SAVE button. This action will save the entered data into in the claim_accident_details table of portal database 26.

The TASK claim screen allows the creator of a TASK to assign that TASK to another supplier (i.e. in the case where one supplier is taking too long to provide a report, etc.) In such a case, the assigning user can go into the EDIT mode of the TASK detail screen and click the REASSIGN TASK button.

| Field | Representation | Status |
|---|---|---|
| Assigned Date | (system generated) | Mandatory |
| Task | (drop down) | Mandatory |
| Assigning Company | (system generated) | Mandatory |
| Assigned By | (system generated) | Mandatory |
| Assigned To | (look up) | Mandatory |
| Status | (drop down) | Mandatory |
| Due Date | (date—mm/dd/yyyy) | Optional |
| Instructions | (scrollable text) | Optional |
| Inform Delegate | (check Box) | Optional |
| Upload Task Instructions | (Text Box) | Optional |

When the above information is entered and the SAVE button is clicked, the entered information will be stored in the claim_task table of portal database 26 and the TASK summary screen will display the bolded fields. In the TASK summary screen, a user may view additional details for a particular TASK by clicking on the relevant link under TASK which will allow the user to see all of the above listed information.

The ATTORNEY claim screen captures and displays details about attorneys. A primer mover 13 or supplier 15 may provide view and/or details about a claim attorney by entering data in the fields as set out below:

| Field | Representation | Status |
|---|---|---|
| Firm Name | (text box) | Optional |
| Claimant | (Lookup) | Optional |
| Attorney Last Name | (text box) | Optional |
| First Name | (text box) | Optional |
| MI | (text box) | Optional |
| Address1 | (text box) | Optional |
| Address2 | (text box) | Optional |
| City | (text box) | Optional |
| State/Province | (look up) | Optional |
| Zip/Postal code | (text box) | Optional |
| Country | (drop down) | Optional |
| Day Phone | (text box) | Optional |
| Evening Phone | (text box) | Optional |
| Cell Phone | (text box) | Optional |
| E-mail Address | (text box) | Optional |
| Tax ID No. | (text box) | Optional |
| Attorney Type | (drop down) | Mandatory |

The ATTORNEY TYPE must be entered and can be either “Defendant”, “Claimant”, “Defendant Lead”, or “Claimant Lead”. After providing the information, the user saves it by clicking the SAVE button which will update the ATTORNEY summary screen with the newly added ATTORNEY details listed above and store the information in the claim_attorney table of claim database 26. When the above information is entered and the SAVE button is clicked, the ATTORNEY summary screen will display the bolded fields as shown above. In the ATTORNEY summary screen, a user may view additional details for a particular attorney by clicking on the relevant link under ATTORNEY TYPE which will allow the user to see all of the above listed information. By clicking the ADD button a user will be able to enter data about another claim attorney.

The DIARY claim screen allows either a prime mover 13 or a supplier 15 to create and view DIARY details, each record of which will contain the following information:

| Field | Representation | Status |
|---|---|---|
| Assigned Date | (system generated) | Mandatory |
| Due Date | (date—mm/dd/yyyy) | Optional |
| Diary Name | (text box) | Mandatory |
| Diary Description | (scrollable text box) | Optional |
| Status | (drop down) | Mandatory |

The field STATUS can be selected to be either “Pending”, “Complete” or “All”. In the DIARY summary screen the user will initially be shown (i.e. as a default) only those diaries which have STATUS as “Pending”. The user may change STATUS to “Completed” or “All” to view other or all diaries, respectively.

The MEDICAL claim screen captures and displays details about a claim physician. A primer mover 13 or supplier 15 may provide view and/or details about a claim physician by entering data in the fields as set out below:

| Field | Representation | Status | Coverage |
|---|---|---|---|
| Medical Group Name | (text box) | Optional | WC, GL, AL, IB, |
| | | | FP, AB |
| Claimant | (lookup) | Optional) | WC, GL, AL, IB, |
| | | | FP, AB |
| Physician Last Name | (text box) | Optional | WC, GL, AL, IB, |
| | | | FP, AB |
| First Name | (text box) | Optional | WC, GL, AL, IB, |
| | | | FP, AB |
| MI | (text box) | Optional | WC, GL, AL, IB, |
| | | | FP, AB |
| Address # 1 | (text box) | Optional | WC, GL, AL, IB, |
| | | | FP, AB |
| Address # 2 | (text box) | Optional | WC, GL, AL, IB, |
| | | | FP, AB |
| City | (text box) | Optional | WC, GL, AL, IB, |
| | | | FP, AB |
| State/Province | (look up) | Optional | WC, GL, AL, IB, |
| | | | FP, AB |
| Zip/Postal Code | (text box) | Optional | WC, GL, AL, IB, |
| | | | FP, AB |
| Country | (Drop Down) | Optional | WC, GL, AL, IB, |
| | | | FP, AB |
| Day Phone | (text box) | Optional | WC, GL, AL, IB, |
| | | | FP, AB |
| Evening Phone | (text box) | Optional | WC, GL, AL, IB, |
| | | | FP, AB |
| Cell Phone | (text box) | Optional | WC, GL, AL, IB, |
| | | | FP, AB |
| E-mail Address | (text box) | Optional | WC, GL, AL, IB, |
| | | | FP, AB |
| Tax ID No. | (text box) | Optional | WC, GL, AL, IB, |
| | | | FP, AB |
| Primary Treating | (Radio Button) | Optional | WC, GL, AL, IB, |
| Physician | | | FP, AB |
| Type of Service Provider | (drop down) | Optional | WC, GL, AL, IB, |
| | | | FP, AB |

Claims portal 12 generates a medical information ID based on the above listed information for a particular physician. The fact that a physician is the Primary Treating Physician can be entered in the appropriate field by indicating “Yes” or “No”. The type of Service Provider can be either an “Individual” or a “Hospital”. When the above information is entered and the SAVE button is clicked, the entered information will be stored in the claim_medical table of portal database 26 and the MEDICAL summary screen will display the bolded fields as shown above. in the MEDICAL summary screen, a user may view additional details for a particular physician by clicking on the relevant link under MEDICAL GROUP NAME which will allow the user to see all of the above listed information.

The DOCUMENTS claim screen provides prime movers 13 and suppliers 15 with a summary of the documents pertaining to the claim being investigated by them and as stored in the claim_documents table of portal database 26. The documents may be sorted by Document Category or Document Type in Ascending or Descending order. The DOCUMENT summary screen will provide the user with a list of all the documents having the following details: (“Document Title”, “Category”, “Type”, “Owner”, “Creation Date”, and “Document Description”). Users may view the details of a specific document by clicking on the relevant link under Document Details which will enable the user to see the above noted information and for a “inform Carrier/Insurer” field as well as the list of users who have the permission for downloading a particular document. A user can add a user using the ADD USER link which will take the user to a supplier search screen from where he can select and add a supplier into the User Document List. Authorized users can VIEW/DOWNLOAD the documents by clicking on the applicable DOCUMENT TITLE link.

The LEGAL PROCEEDINGS claim screen captures details about the court case and its status and contains the following field information:

| Field | Representation | Status |
|---|---|---|
| Case Name | (text box) | Mandatory |
| Court Name | (text box) | Optional |
| Appealed | (drop down) | Optional |
| Filed Date | (date—mm/dd/yyyy) | Optional |
| Date Served | (date—mm/dd/yyyy) | Optional |
| Answer Due Date | (date—mm/dd/yyyy) | Optional |
| Verdict | (text box) | Optional |
| Verdict Date | (date—mm/dd/yyyy) | Optional |
| Settlement Amount | (text box) | Optional |
| Settlement Date | (date—mm/dd/yyyy) | Optional |

The user will be required to provide information as per the format display on the screen listed above. After entering the data pressing the SAVE button will save the information into the claim_lawsuit table in portal database 26.

The HISTORY claim screen enables authorized users to view the history of a particular claim. The function tracks changes in values of some fields pertaining to the claim. Specifically, details are captured for the following “difference indicator” fields: Date (i.e. when the value was changed), Field name (i.e. which field was changed), Previous Value (i.e. what the field was set to previously), Current Value (i.e. what the field contains now), and Changed By (i.e. the identity of the user who changed the field). Any user can review the profile of another user (only the personal and contact details) by clicking the USER NAME link. The user is able to filter the history details by the following fields CHANGED BY (i.e. using a dropdown that lists all claim users) and DATE BETWEEN (i.e. two text boxes for a range of data for which the history should be displayed).

The PAYMENT claim screen allows authorized users to enter details of payments made to different suppliers for a given claim as follows:

| Field | Representation | Status |
|---|---|---|
| Vendor Name | (text box) | Mandatory |
| Currency type | (drop down) | Mandatory |
| Amount | (text box) | Mandatory |
| Check Number | (text box) | Optional |
| Check Date | (date—mm/dd/yyyy) | Mandatory |
| Serve From | (date—mm/dd/yyyy) | Optional |
| Serve To | (date—mm/dd/yyyy) | Optional |
| Pay Type | (look up) | Mandatory |
| Memo | (text box) | Optional |

After providing this information, the user saves it by clicking the SAVE button which will update the PAYMENT summary screen with the newly added details. When the above information is entered and the SAVE button is clicked, the PAYMENT summary screen will display the bolded fields as shown above along with the Claim Base Current value (i.e. as discussed above, the currency of the first financial transaction on the claim which is shown on all financial screens). In the PAYMENT summary screen, a user may view additional details for a particular vendor by clicking on the relevant link under VENDOR NAME which will allow the user to see all of the above listed information for a selected vendor.

The INTERESTED PARTIES claim screen captures and displays details about various interested parties for a claim as follows:

| Field | Representation | Status |
|---|---|---|
| Interested Company | (text box) | Manditory |
| Percentage Share | (text box) | Optional |
| IP TYPE | (text box) | Optional |

A prime mover 13 or supplier 15 can view the summary of all the interested parties using INTERESTED PARTIES SUMMARY.

The CUSTOM FIELDS claim screen captures data specific to that insurer(s) requirements for the specific line of business being worked on. The team administrator for the insurer enters the requirements through the TOOLS —>Custom Fields option (discussed elsewhere).

### User Screens

The GETTING STARTED screen gives basic information about Riskvault®, its uses, and its purpose.

The FAQ'S user screen is listing of the common questions about usage of Riskvault®. The user can select (click) on the question and Riskvault® will display step by step instructions on how to accomplish the task.

The MY PREFERRED SUPPLIERS user screen enables any user to view selected suppliers as per their category. This screen will also allow any user to add/remove preferred suppliers and to search the preferred supplier(s). After the user has provided the details through a search screen, a search will be conducted only on the MY PREFERRED SUPPLIERS data set. These are the suppliers that have been added by the user to his/her preferred supplier list. The user can also have the search executed on the entire supplier database by checking the SEARCH ENTIRE PORTAL box. The user may also confine the search to his/her preferred supplier list. This can be done by clicking on SEARCH MY SUPPLIER link which will take the user to the MY SUPPLIER SEARCH screen. Finally, any user can search suppliers using a SUPPLIER SEARCH screen.

The user can also add a supplier by clicking on the ADD SUPPLIER link displayed in the MY PREFERRED SUPPLIERS summary screen which will take the user to the ADD SUPPLIER screen. The user may remove one or many suppliers from his preferred supplier list by selecting the supplier(s) and clicking the REMOVE link. Upon doing so, the system will check user confirmation by displaying a message (e.g. “Do you really want to remove the selected supplier(s)—Yes/No”). If user clicks “yes”, the system will delete the linkage between the selected suppliers and the logged in user form the database and display the preferred supplier list minus the remove suppliers. If user selects No, user will remain on MY PREFERRED SUPPLIERS screen.

Finally, the user can invite suppliers into the portal (i.e. to subscribe to the portal) through the INVITE SUPPLIER user screen by providing the following information:

| Field | Representation | Status |
|---|---|---|
| First Name | (text box) | Optional |
| Last Name | (text box) | Mandatory |
| E-mail Address | (text box) | Mandatory |
| E-mail message | (scrollable text box) | Mandatory |

The system will generate a Reference Number and an e-mail containing the Reference Number will be sent to the specified e-mail address. Once the invitation order process is completed the user will click the FINISH button and the user will be taken to the MY PREFERRED SUPPLIER SCREEN (discussed above). An e-mail will then be triggered to the specified address along with a system generated Reference ID link and an entry will be made into the user_invited_suppliers table of portal database 26. When the recipient receives the e-mail, they can click on the link and will be taken to the REGISTRATION screen (not shown) where they can register into claims processing system 10. The user can review all of the users that have been invited by him through a INVITED SUPPLIERS screen.

The user can select DOWNLOAD MY PREFERRED SUPPLIERS to receive a CSV file from Riskvault containing the User ID, User Name, Team ID, First Name, Last Name, and Company Name of all users in his preferred supplier list. The MY Toll user screen displays information about the Toll ACCOUNT of the user captured at the time of registration and allows the user to edit this information:

| Field | Representation | Status |
|---|---|---|
| Account Type | (drop down) | Mandatory |
| Currency | (drop down— | Mandatory |
| | prefilled READ ONLY) | |
| Amount | (text box— | Mandatory |
| | prefilled but editable) | |
| Card Type | (Drop Down) | Mandatory |
| Last Name | (text box— | Mandatory |
| | prefilled but editable) | |
| First Name | | |
| Credit Card Number | (text box— | Mandatory |
| | prefilled but editable) | |
| Address 1 | (text box— | Mandatory |
| | prefilled but editable) | |
| Address 2 | (test Box) | Optional |
| City | (Text Box) | Mandatory |
| State | (Text Box) | Mandatory |
| Country | (Text Box) | Mandatory |
| Zip/Postal Code | (Text Box) | Mandatory |
| Phone | (Text Box) | Mandatory |
| Expiration Date | (date—mm/yyyy— | Mandatory |
| | prefilled but editable) | |
| Master Reference | (text box— | Optional |
| Number | prefilled but editable) | |

The user will be shown the summay of the Toll ACCOUNT created at the time of Registration. The user may edit this information by clicking the EDIT Toll link, which will allow him/her to edit some of the fields filled at the time of registration. After modifying the data, the user may click the SAVE button to save the new data. This action will save newly entered data in the user_fee table of portal database 26. If the user has created an Tolle Account, he/she will be able to see the transactions against his/her account by clicking the Toll TRANSACTIONS link from the summary screen. This will take the user to the Toll TRANSACTION screen which provides the creator of the Toll ACCOUNT with a summary of all transactions related to his/her account. This view can be filtered by TOLL USER, or TOLL COMPANY. The Toll Account owner can DOWNLOAD TOLL TRANSACTIONS and a .CSV file will be created and downloaded to the user that contain the TOLL DATE, TOLL AMOUNT, TOLL CURRENCY, TOLL TRANSACTION TYPE, VAULTPACKET NUMBER, REFERENCE NUMBER, TOLL USER, and TOLL COMPANY.

The owner of a MASTER ACCOUNT will be able to perform TOLL ADMIN. This allows the owner of the master account to allow/disallow others who have requested use of his master account the ability to actually use the account. A list of users on his master account will be presented along with the permission of each user (Yes/No). The user can modify the permission and select SAVE to update the permissions, or RESET or BACK to discard the changes.

The user can also view the transaction fee that the system will charge by clicking Toll MATRIX link from the summary screen which will result in the display of the fee structure for the user's currency. Detailed account info will be displayed only for the account owner. For non-owner users (not owner of the account) only the account Reference Number will be displayed.

A check whether the Toll account should be refilled or not will be made when a chargeable transaction is performed, when the net account balance falls below 20% of base amount. The refill amount is either the base amount or greater than the base amount if the transaction requested needs more funds than the base amount. While refilling, a user account ID will be sent to payment gateway and if the information is valid then the required amount will be put into the account. If account validation fails then user can keep doing transactions until the balance falls below 10% of the base amount. At this point additional account information will be sent for validation and the base amount is added to the balance. If this validation also fails then user can continue doing the transactions until the account balance reaches zero. From this point onwards, the user will not be able perform any chargeable transactions.

The MY PROFILE user screen displays information about the user captured at the time of registration and allows authorized users to EDIT the information:

| Field | Representation | Status |
|---|---|---|
| User Id | NEVER EDITABLE | |
| Team Name | NEVER EDITABLE | |
| First Name | (text box—prefilled but editable) | Mandatory |
| Last Name | (text box—prefilled but editable) | Mandatory |
| Industry | (drop down—prefilled—read only) | Mandatory |
| Company Name | (text box—prefilled—read only) | Optional |
| Company Size | (drop down—prefilled—read only) | Optional |
| Your Job Title/Function | (drop down—prefilled but editable) | Mandatory |
| How did you hear about | (drop down—prefilled but editable) | Optional |
| us? | | |
| Preferred Language | (drop down—prefilled but editable) | Mandatory |
| Preferred Currency | (drop down—prefilled but editable) | Mandatory |
| Preferred Screen | (drop down—prefilled but editable) | Mandatory |
| Preferred Logo | (read only) | Optional |
| User Role | (drop down—prefilled but editable) | Mandatory |
| Address 1 | (text box—prefilled but editable) | Mandatory |
| Address 2 | (text box—prefilled but editable) | Optional |
| City | (text box—prefilled but editable) | Mandatory |
| State | (text box—prefilled but editable) | Mandatory |
| ZIP/Postal Code | (text box—prefilled but editable) | Mandatory |
| Country | (drop down—prefilled but editable) | Mandatory |
| Time Zone | (lookup—editable) | Mandatory |
| Day Phone No. | (text box—prefilled but editable) | Mandatory |
| Evening Phone No. | (text box—prefilled but editable) | Optional |
| Fax No. | (text box—prefilled but editable) | Optional |
| E-mail Address | (text box—prefilled but editable) | Mandatory |
| Opt out of Search Entire | (check box) | Optional |
| Portal Results | | |
| Specialty | (drop down—prefilled but editable) | Optional |

The user will be shown the summary of the User Profile that he/she created at the time of Registration. The user may edit this information by clicking EDIT MY PROFILE link, which will enable the user to edit any of the (editable) fields. The bolded fields are editable only by the team administrator and read only for regular team users. After modifying the data, user can click the SAVE button to save the new data into the user_master table of portal database 26. The user may click on the E-MAIL ADDRESS value to open e-mail client. (i.e. for e-mail transfer capability). The user may also specify the display settings for all the search result screens (namely My Preferred Suppliers, Claim Search, Policy Search) by clicking CUSTOMIZE DISPLAY SETTINGS link and entering their setting in the CUSTOMIZE DISPLAY SETTINGS screen. The Preferred Screen dropdown will have following options (Getting Started, Recent Activity, My Diary, My Task). If the screen is Recent Activity then a search is automatically performed for the claims for which the users has permission rights, sorted in reverse order on last activity date, and returning only the 25 most recent claims.

The MY TEAM user screen provides the users with a listing of all their team members. The user may click on the team member name to receive further information about the requested member. In addition the users can select DOWNLOAD MY TEAM RESULTS. This will result in a .CSV file being created and sent to the user that includes: User ID, Team Name, Team ID, First Name, Last Name, and Company Name.

The MY SERVICES user screen provide a place to search for, add, and display services provided by the various users of Riskvault®. The user is presented with a search screen, and when they press SUBMIT the search results are displayed. Further information can be displayed by clicking the link on TYPE.

A user can ADD A SERVICE by clicking the ADD A SERVICE link. The user will need to provide the following information.

| Field | Representation | Status |
|---|---|---|
| Type | (text box) | Mandatory |
| Description | (text box) | Optional |
| Site URL | (text box) | Mandatory |
| Email Address | (text box) | Optional |
| Contact Address | (text box) | Optional |
| Day Phone | (text box) | Optional |
| Evening Phone | (text box) | Optional |
| Cell Phone | (text box) | Optional |

If the user selects SAVE the information will be saved in the services table. If the user selects BACK or RESET then the information will be discarded.

The MY DIARY user screen provides users with access to the manual diaries that each user creates (i.e. simple text file) at the electronic file level.

The MY TASKS user screen provides users with the ability to retrieve all of the tasks that are assigned to the logged in user.

| Field | Representation | Status |
|---|---|---|
| Assigned Date | (read-only) | Mandatory |
| Task | (read-only) | Mandatory |
| Assigning Company | (read-only) | Mandatory |
| Assigned By | (read-only) | Mandatory |
| Assigned To | (read-only) | Mandatory |
| Status | (read-only) | Mandatory |
| Due Date | (read-only) | Optional |
| Instructions | (read-only) | Optional |

In the MY TASK summary screen, the user may view details for a specific task by clicking on the relevant link in the list. This action will take the user to the claim TASK screen as discussed above. The user may view tasks by selecting assigned date range. Only unclosed tasks (i.e. active) will be shown in the summary.

The MY DELEGATED TASKS user screen provides users with the ability to view all the non completed tasks that they have assigned.

| Field | Representation | Status |
|---|---|---|
| Assigned Date | (read-only) | Mandatory |
| Task | (read-only) | Mandatory |
| Assigning Company | (read-only) | Mandatory |
| Assigned By | (read-only) | Mandatory |
| Assigned To | (read-only) | Mandatory |
| Status | (read-only) | Mandatory |
| Due Date | (read-only) | Optional |
| Upload Task Instructions | (read-only) | Optional |
| Instructions | (read-only) | Optional |

By selecting the task in question the user can REASSIGN the task to another adjuster. When a task is REASSIGNED the user rights of the user that previously had the task are set to NONE. This will ensure that the former adjuster does not have rights to the claim any longer, and the rights of the new adjuster are set in accordance with the rules described in the assign task section.

### Utility Screens

The CLAIM SEARCH utility screen allows users to search for a claim in the claim_master table of portal database 26. Any of the following fields should be provided to facilitate the search:

| Field | Representation | Status |
|---|---|---|
| Insured Last Name | (text box) | Optional |
| Insured Company | (text box) | Optional |
| Loss Date | (date—mm/dd/yyyy) | Optional |
| Claimant Last Name | (text box) | Optional |
| Policy Number | (text box) | Optional |
| Coverage | (drop down) | Optional |
| Activity Since | (date—mm/dd/yyyy) | Optional |
| Electronic File Number | (text box) | Optional |
| CSP Claim No. | (text box) | Optional |
| Insurer Claim No. | (text box) | Optional |
| Reference No. | (text box) | Optional |
| Open | (check box) | Optional |
| Reopened | (check box) | Optional |
| Incident | (check box) | Optional |
| Closed | (check box) | Optional |
| Canceled | (check box) | Optional |

The user may specify search parameters by providing a value in the appropriate text box/drop down which will select that field for the search operation. Data will be sorted according to the sort selection chosen prior to submitting the request. The user can conduct an advanced database search by clicking ADDITIONAL SEARCH CRITERION link from the summary screen. This action will require the user to provide value(s) for one of the bolded fields listed above. The user can also specify one or more of the underlined fields listed above. The Status checkboxes form an OR condition and would be appended to the criteria. The default search will be for Open and Reopened claims and will be sorted by Claimant Last Name. The user may initiate the database search operation by clicking the SUBMIT button. Search results will show all the mandatory fields as well as fields that have been customized by the user. The user may click on the Vaultpacket Number to view details of a claim. This action will take the user to the claim screen CLAIM SUMMARY.

The CLAIM CREATE utility screen allows a user to create a claim (i.e. claim creator) either manually or through an extended markup language (XML) upload. The following fields are provided for this purpose:

| Field | Representation | Status |
|---|---|---|
| Add via XML upload | (browse) | Optional |
| Insurer | (look up) | Mandatory |
| Insured Company | (text box) | Optional |
| Insured First Name | (text box) | Mandatory |
| Insured Last Name | (text box) | Mandatory |
| Coverage | (drop down) | Mandatory |
| Accident Date | (date—mm/dd/yyyy) | Mandatory |
| Country | (drop down) | Mandatory |
| Jurisdiction | (drop down) | Mandatory |
| Policy Number | (text box) | Optional |

The user may select to create a claim either via an XML Upload or a Manual Upload. The user may upload the XML file by clicking the BROWSE button. For a manual upload, the user will be required to provide information for the above listed fields (see mandatory fields). Insurer field will have two different text boxes, the TEAM (i.e. of the claim owner) and the COMPANY (i.e. company of claim owner). The user will be required to select a value from the drop down table for the following fields (Country and Jurisdiction (i.e. depending upon country Jurisdiction dropdown will be populated).

The user may obtain policy information by clicking the GET POLICY button. This action will fetch information from the policy master table in portal database 26 and populate the matching fields in the claims master table in portal database 26. In case the policy requested by the user does not exist in the database, an appropriate message (e.g. “Sorry, the requested policy does not exist in the database”) will be displayed to the user. The user must select CONTINUE and will be taken to a blank claim screen where the user can manually enter policy related information.

After entering data, the user may create a CLAIM by clicking the CREATE CLAIM button which will fill the correct fields on the claim screens and take the user to the CLAIM SUMMARY claim screen (discussed above) to begin entering further details. The claim will be made available with full permissions to the claim creator and all team administrators of the Insurer by default. The claim will only be saved in the claim_master table of portal database 26 if all the mandatory information in the claim screens is entered.

The CHANGE PASSWORD utility screen allows the currently logged in user to change their password.

| Field | Representation | Status |
|---|---|---|
| Old Password | (text box) | Required |
| New Password | (text box) | Required |
| Confirm New | (text box) | Required |
| Password | | |
| Security Question | (text box) | Required |
| Security Answer | (text box) | Required |

If the user selects SAVE and all the required information has been entered then the system will save the information. If the user selects RESET then the information will be discarded.

The REPORT utility screen allows the user to select from a list of pre-defined reports, and either submit a report for processing, or customize the report prior to submitting for processing. The report will then be generated by Riskvault® and emailed to the user.

The MANUAL screen contain the Riskvault® manuals. The user selects TOOLS, MANUAL, then select the manual they wish to view. Riskvault® then displays the appropriate manual in a separate browser window.

### Team Administrator Screens

The LOCATION MAINTENANCE team screen allows the user to maintain the LOCATIONS master table and requires the user to input the following information:

| Field | Representation | Status | Coverage |
|---|---|---|---|
| Location Name | (text box) | Optional | WC |
| Entity Name | (text box) | Optional | WC |
| Division Name | (text box) | Optional | WC |
| Region Name | (text box) | Optional | WC |
| Section Name | (text box) | Optional | WC |

The user can add/modify all of the above listed fields and they are related to each other in the hierarchical order shown top down. There will be a list box that will contain a list of all the locations. Clicking on a LOCATION the user will be able to see all the entities in that location. This list of entities will appear in a separate list box. User can click on an ENTITY to get a list of all the divisions in a separate list box. User can see all the regions in a division and all the sections in a division by clicking on the DIVISION and SECTION list boxes respectively. This function is specifically applicable to workers compensation claims (as indicated) since it allows users to review claim information by geographic location.

To add a location, entity, division, region or section user can input the value in a text box that is provided over the list box for that data element (location, entity, division, region or section) and click on the SAVE button. To modify a particular value in the list box, the user will select that value from the list box and type the new value in a text box provided above the list box. User can save the modification by hitting the Save button.

The TEAM PREFERRED SUPPLIERS team screen enables a team administrator to view, add, remove or invite suppliers to join the TEAM PREFERRED SUPPLIERS list, the records of which are stored in team_preferred-supplier table of portal database 26. This function will be made available only to team administrator(s). Depending upon the login information, system will identify whether the logged in user is an administrator or not. If the logged in user is an administrator, then this function will be similar in functionality to the PREFERRED SUPPLIERS user screen (discussed above) and will incorporate its the associated INCLUDE SUPPLIERS, INVITE SUPPLIERS, INVITED SUPPLIERS, DOWNLOAD TEAM PREFERRED SUPPLIERS, MY SUPPLIER SEARCH screens, otherwise these options will not be presented. The team administrator may add, view, remove or invite suppliers to the PREFERRED LIST of the team i.e. records of which are stored in the team_preferred_suppliers table of portal database 26.

The TEAM ADMINISTRATION team screen enables the team administrator to view the listing of all team members, set the team members privilege level (inactive user, unapproved user, user, administrator), invite new users to join the team, and set the team MESSAGE BOARD. If the team administrator changes the user level of any user listed he must select SAVE or the changes will be discarded. If the administrator selects MESSAGE BOARD he is presented with a large area to type text into. If he selects SAVE then whatever he has typed in will be displayed to his TEAM MEMBERS upon their next login to Riskvault®.

The TEAM ADMINISTRATION team screen enables team administrators to assign permissions to other team members. This function is only available only to the administrator(s) of the team. Depending upon the login information, system will identify whether the logged in user is an administrator or not. If the logged in user is an administrator, the system will display the list of team members along with their current (last assigned) permissions status. The administrator can then modify the permission status of a user using one of the following: (Administrator, User Unapproved user, Inactive User). After assigning permissions to the team members, the team administrator may click the SAVE button, doing which, the permissions currently assigned to the team members will be saved in the claim_document_permission and claim_tab_permission tables of the portal database 26.

A team administrator can also invite any unregistered user into his/her team and upon registration the invited user will become an approved user for the team using the INVITE TO TEAM screen. This screen includes a check-box called “Invited User will use my fee Master Account” but will only be available if the inviting user is an fee administrator. Users registering using the included link will automatically be attached to the fee master account indicated, but will still need to be verified by the fee administrator prior to performing any chargeable transactions.

The CUSTOMIZED FIELDS team screen enables team administrators to add up to 20 custom labeled fields per coverage (line of business). When the team administrator selects this function they are taken to a screen that has a drop down for coverage, and displays the 20 fields below the coverage. To make changes the team administrator simply selects the coverage they wish to change, and then types the description of the item they wish to track into the next available field and selects SAVE. If they select RESET then the changes are discarded.

### Portal Administator Screens

The MESSAGE BOARD screen allows the portal administrator(s) to post a message that will be displayed to every user upon login to Riskvault®.

The PORTAL ADMINSTRATION screens are where the portal administrator can modify/add values to all the lookup tables in Riskvault®. Each lookup is done by PORTAL NAME (lookup table name), and LANGUAGE. The results are displayed when the portal administrator presses SEARCH. If the portal administrator selects the reference code he will be taken to the EDIT PORTAL DETAILS screen. On this screen the description for the portal value can be edited, and the portal value can be activated/inactivated. Changes will only be saved if the portal administrator selects SAVE, otherwise all changes will be discarded.

A new lookup/dropdown value can be added by selecting PORTAL ADMINISTRATION and then selecting ADD. This takes the administrator to the ADD PORTAL DETAILS screen. The administrator selects the DOMAIN NAME (Lookup table name), and Language to be added, then they add the DOMAIN VALUE and REFERENCE CODE. Riskvault® will then add the proper codes for all languages supported, however, the administrator is still responsible for supplying the correctly translated text for each language in Riskvault®.

The portal administrator may get a .CSV file of any of the tables by selecting PORTAL ADMINISTRATION, selecting the DOMAIN NAME and LANGUAGE, pressing SEARCH, and finally selecting DOWNLOAD PORTAL VALUES. This will provide the administrator with a .CSV file containing: DOMAIN TABLE NAME, VALUE, and REFERENCE CODE.

PORTAL REPORTS are where the portal administrator can go to pull information from Riskvault® on REVENUE, USERS, CLAIMS, TEAMS, DOCUMENTS and REPORTS.

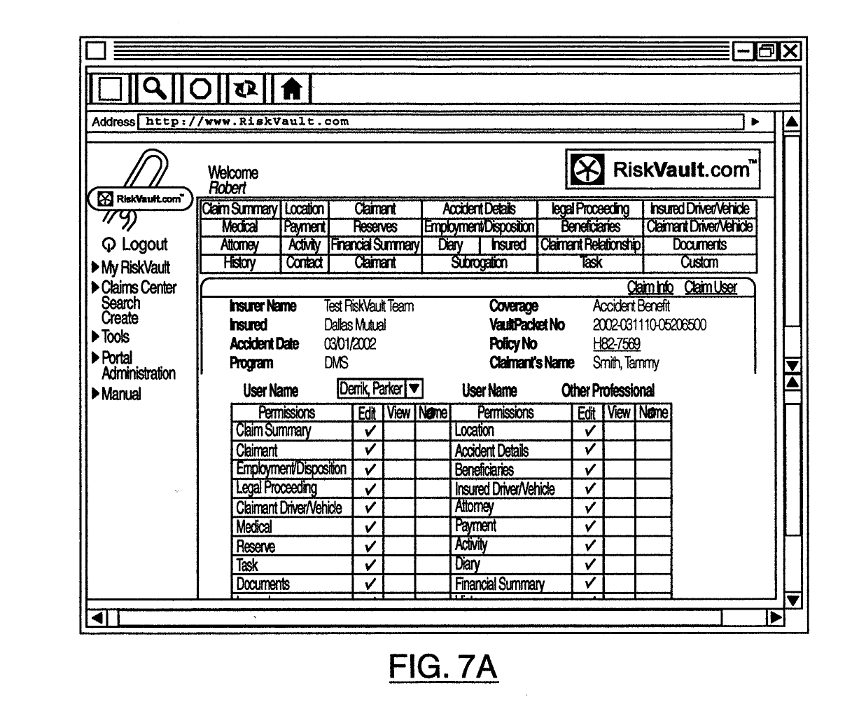

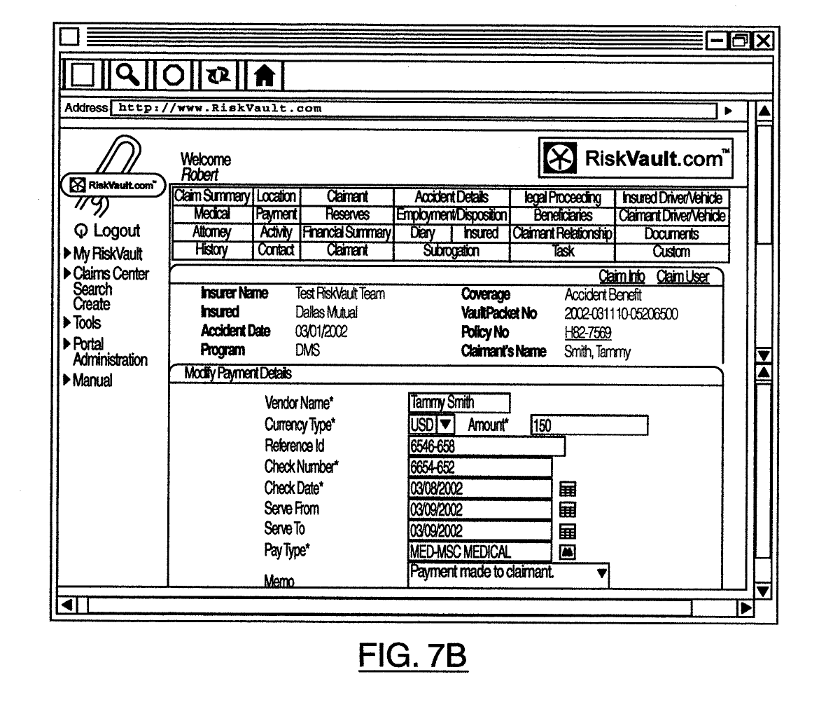

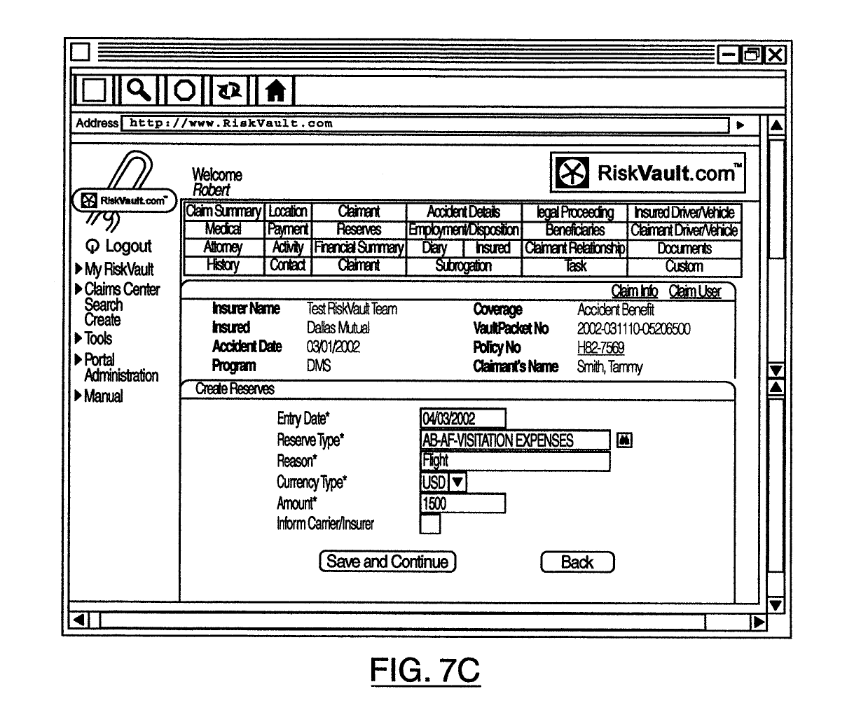

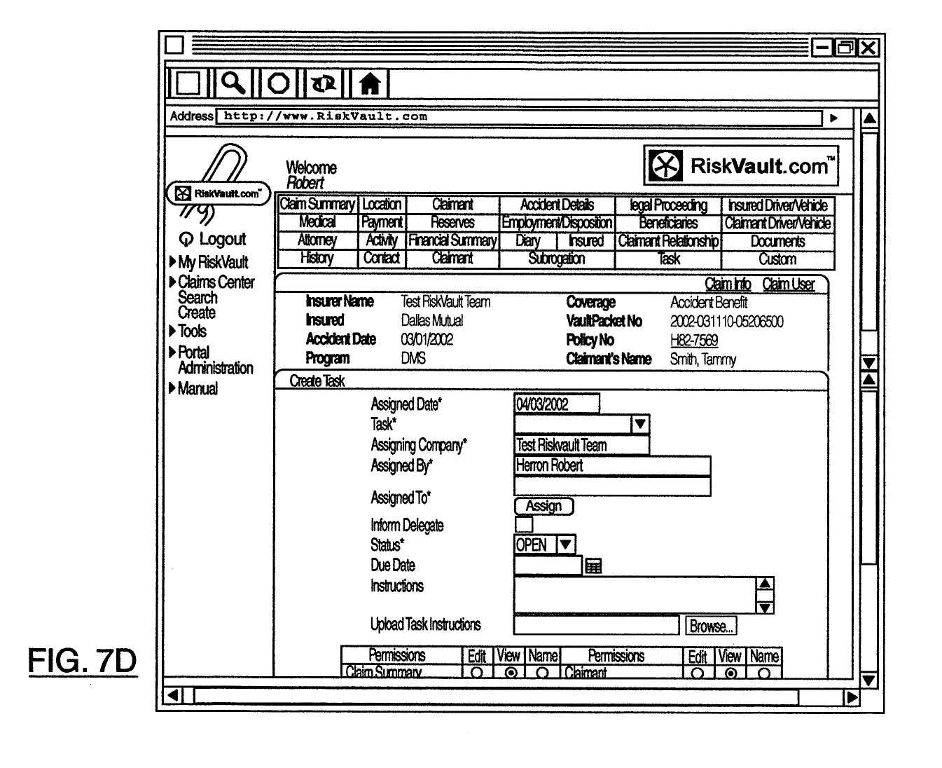

Referring to FIG. 7A is a sample screen capture of the user interface provided by claim processing system 10 as it is displayed within a generic Web browser, shown generally as 70. This user interface illustrates a permission profile of a user and is a good starting point for a discussion of permissions within claim portal 12. As shown in FIG. 7A, three permission levels can be set for a claim user, namely EDIT (i.e. the user can perform add and update activities for the claim data), VIEW (i.e. the user will be able to view the claim data within its screen summary), and NONE (i.e. the particular claim data will not be shown to the user anywhere including within search results).

As shown in FIG. 7A the sample user permission profile indicates that this particular user has EDIT permission to the various screens including PAYMENT, RESERVE and TASK screens. When the user links to the PAYMENT screen, the user is provided with the screen illustrated in FIG. 7B illustrating the fields of the PAYMENT screen (i.e. VENDOR NAME, CURRENCY, REFERENCE ID, CHEQUE NUMBER, CHEQUE DATE, SERVE FROM, SERVE TO, and PAY TYPE). When the user links to the RESERVE screen illustrated in FIG. 7C, the user can view the fields of the RESERVE screen (i.e. TYPE, CURRENCY, AMOUNT etc.) The user can also link to the TASK screen where the various fields are displayed. The user can edit each of the fields within each of these screens since the permission level set for each of these screens is EDIT.

Generally, any registered system user can create a claim. As a note concerning terminology, a registered system user is a general user of claim processing system 10 and a “claim user” is specifically a user that either has created a claim or has been added by a claim user. The creator of a claim will be have his/her permission set to the highest level permission. All team administrators for the insurer/broker on a claim (i.e. the insurer) will also automatically be set to the highest level permissions. Also, any claim user can add a user to a claim as long as the assigning user has EDIT rights to the CLAIM SUMMARY screen. Added users will be listed in the claim history table and displayed on the HISTORY screen to authorized users. When a claim user is added it is provided with a default VIEW permission for the claims_summary table displayed within the CLAIMS SUMMARY screen and default NONE permission for all other applicable tables and screens.

A claim user can modify permissions of a user whose permissions are not greater than the modifier's permissions. Also, any claim user can grant permission to any other claim user but the permissions granted cannot be greater than the granter's permissions. Once a claim user is deleted from the claims user list, all the permissions for that user will be set to NONE. A claim can be closed/reopened by a person who has EDIT permission to the CLAIM SUMMARY screen.

A claim user can assign a TASK if he/she has all of the following permissions, namely VIEW permission for the CLAIM SUMMARY and DOCUMENT SUMMARY screens and EDIT permission for the ACTIVITY, TASK and DIARY screens. If a user does not have these requisite permissions, then upon attempting to assign a TASK, the user will be provided with a message that advises that the user does not have the required permissions to assign a TASK. The assigned to user can be a claim user but can also be any other registered system user. The assigned user will have all of its permissions set to NONE except for the above-noted permissions (i.e. would be in a position to assign tasks to another user). If the assigned to user is not a claim user than he/she will be added as a claim user. If the assigned to user is not a claim user and the box REVOKE RIGHTS on DUE DATE is checked by the subscribing user (default is unchecked) then the permissions of the assigned to user will be revoked (i.e. all permissions set to NONE) after the due date. Once a TASK has been created only an assignor can edit specific fields of the TASK (e.g. STATUS, INSTRUCTION and DUE DATE). The assigned to user can only change the STATUS of a TASK to “closed” which completes the task and converts the task into an activity.

The owner of a document has VIEW/DOWNLOAD DOCUMENT permission. Any claim user which has such permission for a document (and EDIT permission for the DOCUMENTS screen) can set the same permission for other claim users. After uploading the document in the ACTIVITY screen, VIEW/DOWNLOAD DOCUMENT permissions can be set in the DOCUMENTS screen. If a claim user who does not have VIEW permissions for the DOCUMENT screen is given permissions to VIEW/DOWNLOAD a document then claim processing system 10 will grant him/her with such permissions. Only the users that have VIEW/DOWNLOAD DOCUMENT permission and EDIT permission can get in the EDIT DOCUMENT screen.

Claim users which have EDIT permissions for the CLAIMANT and INSURED screens can view the POLICY document. Only TEAM ADMINISTRATORS can have access to and perform LOCATION MAINTENANCE, POLICY MAINTENANCE, TEAM PREFERRED SUPPLIERS,TEAM ADMINISTRATION, and CUSTOM FIELDS.

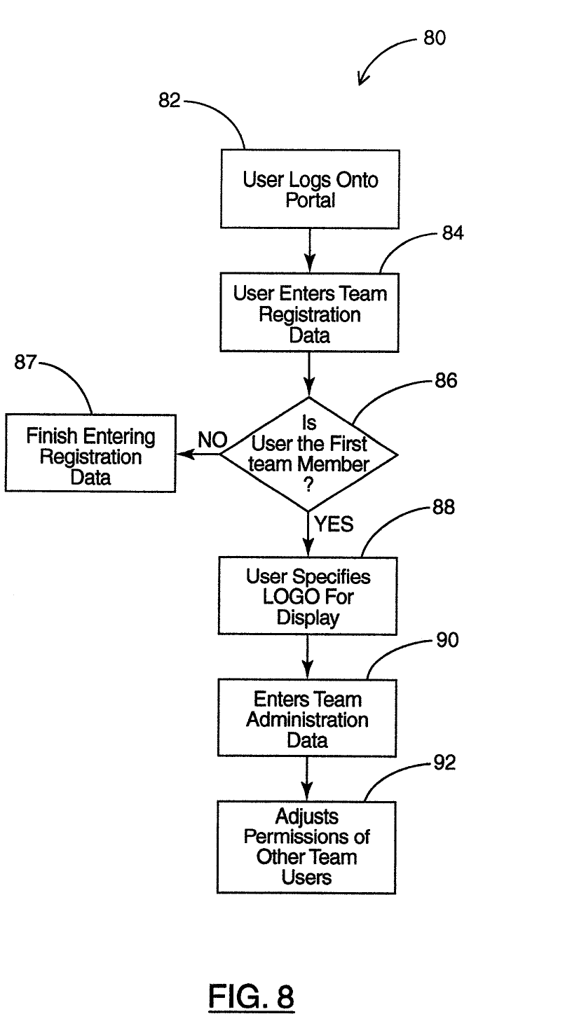

Referring to FIGS. 1, 2 and 8, the flow chart diagram (FIG. 8) shows one embodiment of the steps 80 executed by claims portal 12 to implement the TEAM REGISTRATION routine for claims processing system 10. Specifically, the user logs onto claims processing system (at step 82) and then registers team information (at step 84). The following information is required from the user:

| Field | Representation | Status |
|---|---|---|
| Team Name | (text box) | Mandatory |
| User Id | (text box) | Mandatory |
| Password | (text box) | Mandatory |
| Re-enter Password | (text box) | Mandatory |
| Security Question | (text box) | Mandatory |
| Security Answer | (text box) | Mandatory |
| First Name | (text box) | Mandatory |
| Last Name | (text box) | Mandatory |
| Industry | (drop down) | Optional |
| Company Name | (text box) | Mandatory |
| Company Size | (drop down) | Optional |
| Job Title/Function | (drop down) | Optional |
| How did you hear | (drop down) | Optional |
| about us? | | |
| Preferred Language | (drop down) | Mandatory |
| Preferred Currency | (drop down) | Mandatory |
| Preferred Screen | (drop down) | Optional |
| Preferred Logo | (browse) | Optional |
| Promotion Code | (text box) | Optional |
| User Role | (drop down) | Mandatory |
| Address 1 | (text box) | Mandatory |
| Address 2 | (text box) | Mandatory |
| City | (text box) | Mandatory |
| State/Province | (text box) | Mandatory |
| ZIP/Postal Code | (text box) | Mandatory |
| Country | (drop down) | Mandatory |
| Day Phone No. | (text box) | Optional |
| Evening Phone No. | (text box) | Optional |
| Fax No. | (text boxes) | Optional |
| E-mail Address | (text box) | Mandatory |
| Specialty | (drop down) | Optional |

If the user is the first team member (determined at step 86) then this user is considered to be the team administrator (as discussed above) and can specify the desired logo by attaching it during the registration process. This logo will be displayed on the screens, to which user has access, when he/she next logs in (and later by team members). If the user is not the first team member than the user is not entitled to specify the team logo and simply finishes entering registration information (at step 87). However, if the user is the team administrator, then he/she enters the TEAM ADMINSTRATION screen (as discussed above) (at step 90) and can invite other users to the team using the INVITE TO TEAM link (at step 92) and adjust the permissions of the other team members (at step 94).

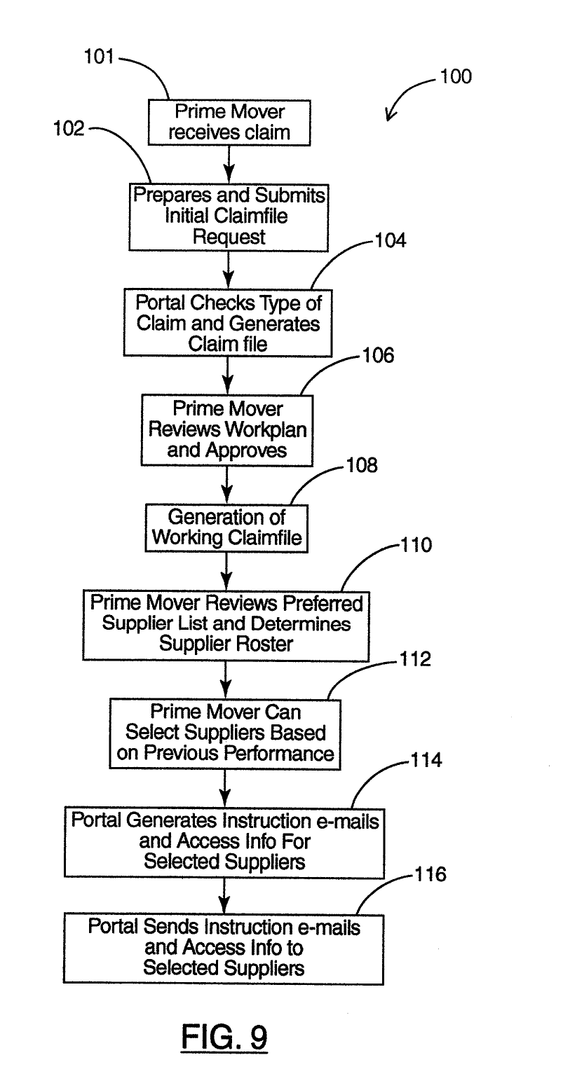

Referring to FIGS. 1, 2 and 9, the flow chart diagram (FIG. 9) shows one embodiment of the steps 100 executed by claims portal 12 to implement the CLAIM INITIATION routine for claims processing system 10. Specifically, the prime mover 13 receives notice of a claim (at step 101) and initiates a claim file request through the CLAIM CREATE screen (as previously discussed) (at step 102). Claims portal 12 then receives applicable information from prime mover 13. Based on the type of claim, a claim file 40 will be developed (at step 104) (e.g. will adjust what information is required from the users depending on the insurance classification at issue).

Prime mover 13 then reviews the claim file 40 and provides final approval (at step 106) and the working claim file is generated (at step 108). Prime mover 13 then reviews a list of team or user preferred suppliers (at step 110) and determines the supplier roster for this particular claim file. Prime mover 13 can search and select suppliers based on various criterion (at step 112) including past performance (e.g. cost, time of delivery of report, etc.) Finally, when prime mover 13 enters INVITE SUPPLIER screen and requests suppliers, claim portal 12 will generate instruction e-mails and access information (i.e. Reference ID link) for selected suppliers (at step 114) and sends the instruction e-mails to suppliers (at step 116).

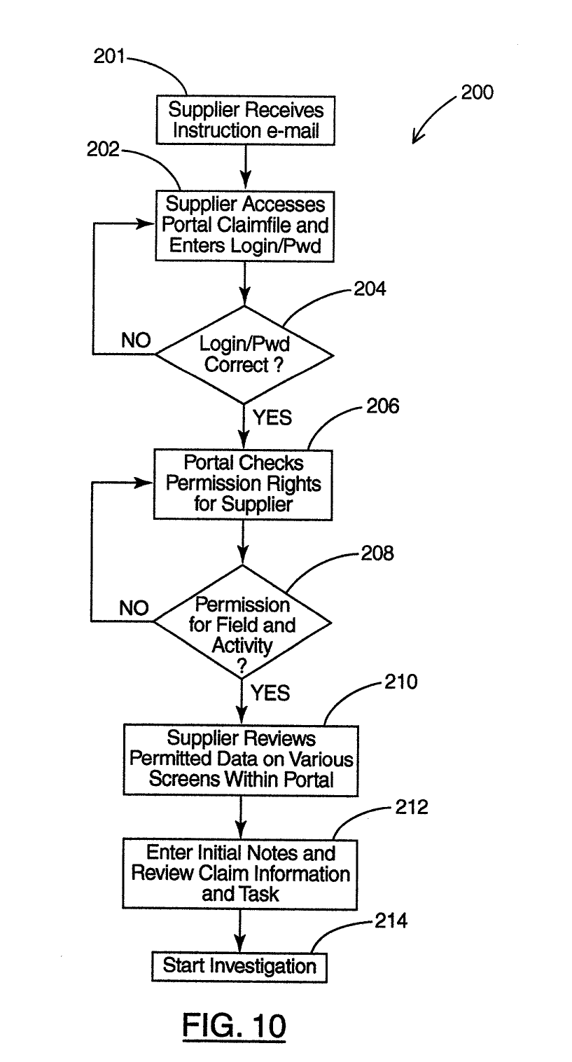

Referring next to FIGS. 1, 2 and 10, the flow chart diagram (FIG. 10) shows one embodiment of the steps 200 executed by claims portal 12 to implement the SUPPLIER INSTRUCTION routine for claims processing system 10. Specifically, supplier 15 receives notice of a task assignment from claim processing system 10 by e-mail (at step 201) and logs on to claims processing portal 12 (at step 202) preferably using the Reference ID link provided in the invitation e-mail message. Claims portal 12 checks login and password and claim file access code to ensure that supplier 15 is authorized for admission to the claim file 40 (at step 204). If not, supplier 15 is not allowed access. If so, then claims portal 12 checks permission rights for supplier 15. As supplier 15 navigates through claims portal 12, his/her permission rights are checked each time a new screen is entered and the appropriate amount of information is displayed (at step 210). Supplier 15 then can enter notes within claim file 40 by entering comments in various user screens and reviews claim related information by navigating through the relevant screens (and view field information to which the supplier has permission rights). Supplier 15 then begins investigation (at step 214).

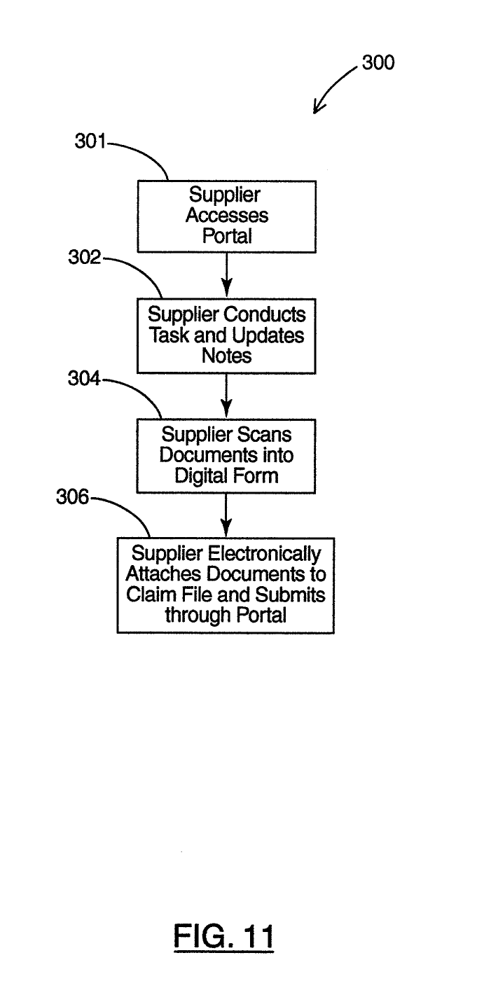

Referring next to FIGS. 1, 2 and 11, the flow chart diagram (FIG. 11) shows one embodiment of the steps 300 executed by claims portal 12 to implement the SUPPLIER WORKING routine for claims processing system 10. Specifically, supplier 15 logs onto claims portal 12 and accesses the claim file 40 (at step 301) by viewing and interacting with the appropriate system screen (i.e. ATTORNEY or MEDICAL, etc.) Suppler 15 then conducts the assigned task and updates information within claims portal 12 as appropriate (at step 302). Supplier 15 then scans report documents (e.g. photographs, video, medical records, etc.) into digital form (at step 304) and then electronically attaches these electronic documents to claim file 40 by sending them over communications network 25 to claims portal 12 where they are stored within document server 36 (at step 306).

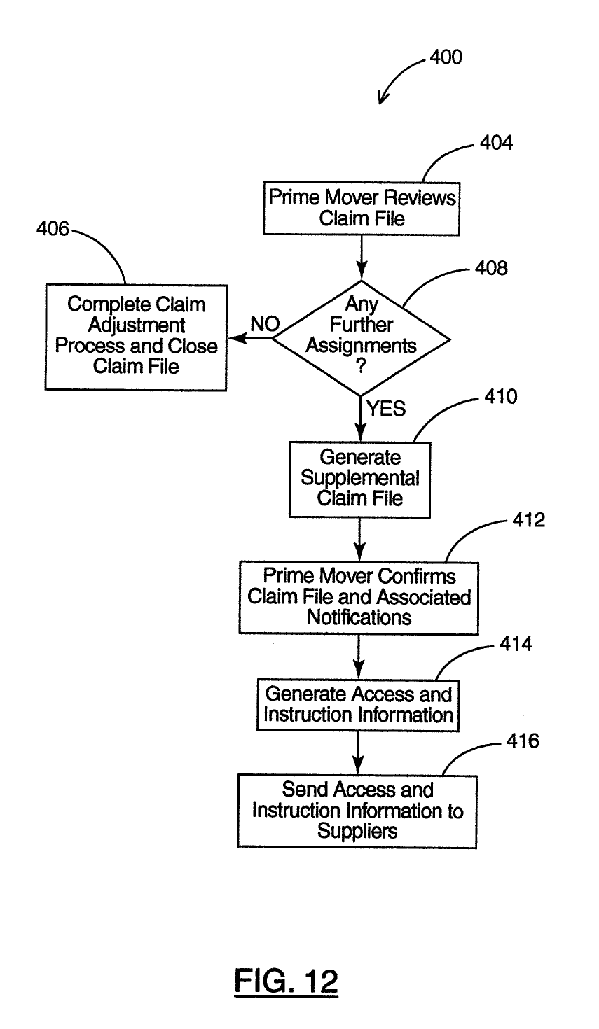

Referring next to FIGS. 1, 2 and 12, the flow chart diagram (FIG. 12) shows one embodiment of the steps 400 executed by claims portal 12 to implement the PRIME MOVER WORKING routine for claims processing system 10. Specifically, prime mover 13 logs onto claims portal 12 and accesses the claim file 40 (at step 404) and checks the status of the assigned tasks by viewing and interacting with the appropriate system screen (i.e. TASK screen as discussed above). Prime mover 13 decides whether additional assignments of tasks to suppliers 15 are necessary (at step 108). If not, then prime mover 13 completes claim adjustment process and closes claim file 40 (at step 406). If there are additional tasks which require assignment, then prime mover 13 continues to develop the claim file 40 (at step 410) by selecting appropriate suppliers 15 for the remaining tasks. Prime mover 15 confirms claim file 40 (at step 412) and an e-mail message containing access and instruction information (i.e. Registration ID link) is generated by claims portal 12 (at step 414) and subsequently sent to suppliers 15 (at step 416).

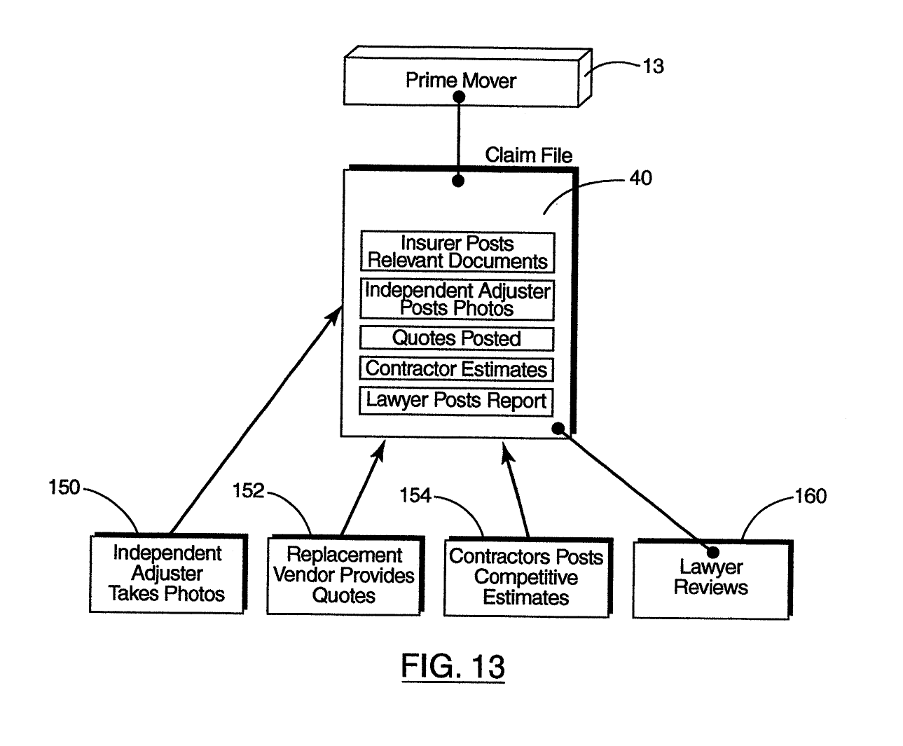

Now referring to FIGS. 1, 2 and 13, is a schematic diagram illustrating the basic data flow that occurs within claims processing system 10 for a typical case. When prime mover 14 (i.e. either an insurer, risk manager or broker) receives an insurance claim and generates a new clam instruction (including all necessary information) to claims portal 12 over communications network 25 (not shown) a portal claims file 40 is created by prime mover 13 and a number of assigning e-mails are sent to suppliers 15 which have been selected to work on the particular claim file 40.

For example, adjuster 150 will log onto claims portal 12 through his/her Web browser using his/her particular login and password information and review the specific data recorded within the newly setup portal claim file 40. Because claims portal 12 is interactive in terms of those who have rights to the claim, portal claim file 40 may or may not have notes and or documents already present, put there by the person making the assignment (ie the insurer, risk manager or broker). The person assigning claim file 40 provides instructions to the adjuster within the portal claim file 40.

Adjuster 150 will commence an investigation and populate the financial risk management section with relevant data (e.g. claimant name, reserves, date of loss etc.) Since a number of users have access to portal claim file 40, the various fields may be populated by any user with the appropriate permission rights. The data and values within this field can be revised and adjusted throughout the claims process. As adjuster 150 moves forward with the investigation, he/she will enter activity notes to portal claim file 40 which reflect the actions being taken on a claim. The notes can be completed by anyone having the appropriate permission rights to portal claim file 40. As the investigation continues, adjuster 150 will gather supporting documents and prepare a report to the prime mover 13. The report including supporting documents will be scanned, electronically submitted and included within portal claim file 40.

Anyone with the appropriate permission rights to portal claim file 40 will be able to attach documents. Therefore, in the case of a lawyer 160 being requested to provide a report commenting on legal issues raised throughout the adjusters investigation, they simply attach their report to portal claim file 40 rather than courier/fax their report (as was previously the case). The portal claim file 40 therefore becomes a repository of all information relating to a single claim to the degree that it was originally outsourced. Similarly, replacement vendor 152 can for example provide quotes and submit the digital report to claim file 40. Also contractors 154 can post competitive estimates on claim file 40 for consideration.

At a higher level, claims portal 12 provides a single view to a prime mover 13 of all of their outsourced claims. In the case of those adjusting firms with systems, it is likely that they will interface to the portal as their system will support back office logic. In the more likely case of adjusting firms who do not have a system, the portal provides one with a minimal capital investment (digital camera, scanner and internet browser). Claims portal 30 serves to remove the claims and risk management data from proprietary systems and centrally stores it.

It should be understood that the data embedded within portal claim files 30 can be also be utilized by various users for risk management purposes as briefly discussed above. By stripping certain fields of personal data from a collection of portal claim files 30, debugged consolidated data can be formed which is then of use to underwriters 14, intermediaries 16 and risk managers 18. In this way, claims processing system 10 allows prime movers 13 (e.g. insurers 14, intermediaries 16, and risk managers 18) to consolidate all common acquired data for risk management, statistical analysis, and other related purposes.

For example, prime movers 13 (and other authorized user) can review and chart the performance of various suppliers 15 according to the data that is collected within claim files database 26 on a real-time basis. This data can be used to compile management information reports on each of the suppliers 15 using indica such as average length of time to file an initial report, etc. An example claim service provider performance management information chart is shown in the following table:

| Criteria | CSP 1 rating | CSP 2 rating | CSP 3 rating |
|---|---|---|---|
| avg. fee | 1000 | 2000 | 1500 |
| (aggregate/banded) | | | |
| avg. reporting time | 10 days | 15 days | 20 days |
| (aggregate) | | | |
| avg. investigation time | 1 day | .5 days | 1.5 days |
| (banded) | | | |
| avg. phone time | .5 days | .5 days | .3 days |
| (banded report) | | | |
| avg. correspondence | 1 days | 1 days | 1 days |
| time (banded) | | | |
| avg. claim paid time | 5 days | 8 days | 3 days |
| (aggregate/banded) | | | |
| avg. time to preliminary | 3 days | 5 days | 8 days |
| report | | | |
| avg. time to first report | 5 days | 8 days | 3 days |
| avg. file duration time | 20 days | 25 days | 35 days |
| correlation report comparing | $25,000 | $35,000 | $20,000 |
| amt. spent on investigating | | | |
| and indemnity for a set of | | | |
| claims | | | |

This information can be used by prime movers 13 to determine preferred suppliers on an on-going basis. The open-source access that is provided by claims processing system 10 then allows prime movers 13 to easily move their business to suppliers 15 which rank higher on critical indicia. As previously discussed, a high quality of risk management information is available from claims processing system 10 due to the fact that all information is compiled in one centralized place and since data entry errors are substantially reduced due to the ability of the various prime movers 13 and suppliers 15 to enter their own respective information and to ensure that this information is correct on-line in real time.

This flexibility results in increases in overall service levels and reductions in costs for prime movers 13. Other benefits include the ability to collect data relating to a particular category of objects in a centralized manner. For example, centralized collection of data relating to homeowner theft claims would enable collection of management information on annual spending on commonly stolen products (e.g. televisions, VCRs, etc.). This information would allow prime movers 13 the opportunity to negotiate pricing deals with manufacturers or suppliers for additional cost savings.

Also, claims processing system 10 allows risk managers 18 to initiate claim file processing themselves and to be involved in the processing of claims thereafter. Previously, risk managers 18 were required to provide claim files to an insurer 14 for processing.

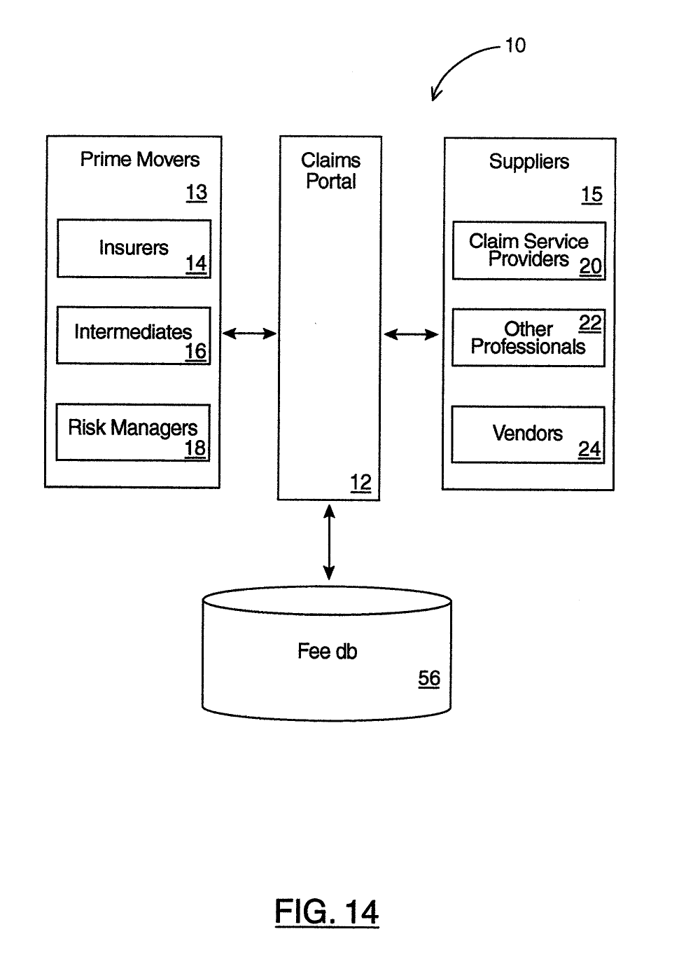

FIG. 14 is a schematic diagram of the revenue model for claims processing system 10. As previously discussed, FEE database 56 is used to gather revenue from suppliers 15 by charging an appropriate (i.e. flat) fee for each data transaction. revenue is realized either by updating details on a claim or by the attachment of documents. Accordingly, claims processing system 10 derives revenue from suppliers 15 when they update details on a claim or when they wish to attach documents to portal claim file 40 to offset costs from prime movers 13.

The FEE tables within portal database 26 and the IVY TOLL screen have been previously discussed. Essentially, each user upon creation of their account opens up an TOLL account utilizing an electronic, pre-funded account and authorize a fill/refill limit (e.g. $500 USD per refill). The user's account is immediately debited the fill/refill amount and the funds are placed into the user's TOLL account. As the user works within claims portal 12, billable transactions are performed and the amount (i.e. the cost of posting a report of say 30 pages) is deducted to the posting user. When the balance in the user TOLL account reaches 20% of the refill limit (as previously discussed), an e-mail is sent to the user notifying them that claim portal 12 is automatically refilling the TOLL account to the preset limit.

It should be understood that several different architectures can be used to implement system 10. Specifically, one alternative implementation for claims processing system 10, would be where the user interface 14 sends messages to and queries information from transaction destinations 12 via the schedule manager 16 which is hosted on a web server associated with each transaction destination 12. In this case, schedule manager 16 operates at the web server of the transaction destination 12 according to the order schedules entered by the user through user interface 14.

Another alternative implementation for system 10, is where the user interface 14 and schedule manager 16 are combined to run together on the user's desktop browser software. All communications are carried out with the transaction destinations 12 using a standardized messaging protocol or by integrating the transaction order interface 18 into the user's software system. In such a case, it is necessary for the user's browser to remain open in order to transmit and receive messages for controlling and managing orders as stipulated by the order schedules. It should be understood that it is possible for the user to specify that various transaction destinations may be chosen to transact with.

The insurance claim processing system and method of the present invention provides a plurality prime movers 13 with the ability to select, interact with, assign tasks to, monitor, and evaluate claim service suppliers 15. As selected suppliers completed their assigned tasks, they are able to electronically attach electronic report documents to the claim file. Accordingly, claim processing system 10 eliminates the need for cumbersome hardcopy versions of data records and attachments as well as the wasteful and potentially dangerous reentry of existing data. Another especially useful result of maintaining and monitoring all electronic activity within claim file is that the relative performance of suppliers can be evaluated based on comparative performance records maintained by the system and future selection of suppliers can be informed by historical performance of suppliers.

As will be apparent to those skilled in the art, various modifications and adaptations of the method and system described above are possible without departing from the present invention, the scope of which is defined in the appended claims.

We claim:

1. A method of processing an insurance claim by assigning tasks to suppliers, the method comprising the steps of:
(a) generating a claim datafile having data sections;
(b) selecting at least one supplier from a plurality of suppliers;
(c) assigning tasks to said at least one supplier over a communications network;
(d) providing each of said at least one selected supplier with access to claim datafile;
(e) providing said at least one selected supplier with the ability to electronically attach documents relating to completed tasks to the claim datafile over the communications network.

2. The method of claim 1, wherein step (d) further comprises providing each of said at least one selected supplier with access to selected data sections of claim datafile.

3. The method of claim 1, further comprising the step of obtaining and recording performance data associated with to the completion of each assigned task by each of said at least one supplier.

4. The method of claim 3, further comprising the step of evaluating the performance of said at least one supplier according to said performance data.

5. The method of claim 4, wherein step (b) further comprises selecting at least one supplier from the plurality of suppliers according to previous performance data associated with each at least one supplier.

6. The method of claim 1, wherein step (e) further comprises charging an administrative fee to said at least one supplier for the ability to electronically attach documents relating to completed tasks to the claim datafile.

7. A system for processing a claim file by assigning tasks to suppliers, said system comprising:
(a) a network server for generating and maintaining a claim datafile, said claim datafile having a plurality of data sections;
(b) a communications network coupled to said network server;
(c) a user interface for selecting at least one supplier from a plurality of suppliers;
(d) a user interface for assigning tasks to said at least one supplier over a communications network;
(e) a user interface for providing each of said at least one selected supplier with access to said claim datafile; and
a user interface for providing said at least one selected supplier with the ability to electronically attach documents relating to completed tasks to the claim datafile over the communications network.

8. The system of claim 7, wherein said network server includes a program for selectively providing each of said at least one selected supplier with access to selected data sections of claim datafile.

9. The system of claim 7, wherein said network server includes a program for obtaining and recording performance data associated with to the completion of each assigned task by each of said at least one supplier.

10. The system of claim 9, said network server includes a program for evaluating the performance of said at least one supplier according to said performance data.

11. The system of claim 10, said network server includes a program for selecting at least one supplier from the plurality of suppliers according to previous performance data associated with each at least one supplier.

12. The system of claim 7, wherein said network server includes a program for charging an administrative fee to said at least one supplier for the ability to electronically attach documents relating to completed tasks to the claim datafile.

13. A claim datafile for use in an insurance claim processing system which adjusts an insurance claim by assigning tasks to selected suppliers, the claim file comprising:
(a) a user interface that allows for the selecting of at least one supplier from a plurality of suppliers;
(b) a user interface for assigning at least one task to the at least one selected supplier; and
(c) a user interface which provides said at least one supplier with the ability to electronically attach a report document to the claim datafile.

14. The claim datafile of claim 13 further including a user VIM interface which provides said at least one supplier with selective access to data contained within claim datafile.

15. The claim datafile of claim 13 further including a user interface for evaluating each of said at least one selected suppliers based on its performance of said at least one task and generating performance data.

16. The claim datafile of claim 13 wherein the user interface that allows for the selecting of at least one supplier from a plurality of suppliers also allows for the selecting of at least one supplier on the basis of historical performance data.
